(19) United States
(12) Patent Application Publication
(10) Pub. No.: US 2018/0374313 A1
(43) Pub. Date: Dec. 27, 2018

(54) MULTIPLAYER VARIABLE SKILL OBJECTIVE INTERACTIVE GAMING SYSTEM

(71) Applicant: Gamblit Gaming, LLC, Glendale, CA (US)

(72) Inventors: Bryce Cire, Los Angeles, CA (US); Frank Cire, Pasadena, CA (US); Darion Lowenstein, Los Angeles, CA (US)

(21) Appl. No.: 16/017,976

(22) Filed: Jun. 25, 2018

Related U.S. Application Data
(60) Provisional application No. 62/539,703, filed on Aug. 1, 2017.
(60) Provisional application No. 62/533,610, filed on Jul. 17, 2017.
(60) Provisional application No. 62/525,929, filed on Jun. 28, 2017.
(60) Provisional application No. 62/524,332, filed on Jun. 23, 2017.

(51) Int. Cl. G07F 17/32

(52) U.S. Cl. CPC G07F 17/3276; G07F 17/3244; G07F 17/3223; G07F 17/3262

(57) ABSTRACT

A multiplayer variable skill objective interactive gaming system is disclosed.

### CROSS REFERENCE TO RELATED APPLICATIONS

This application claims the benefit of U.S. Provisional Patent Application No. 62/524,332, filed Jun. 23, 2017, U.S. Provisional Patent Application No. 62/525,929, filed Jun. 28, 2017, U.S. Provisional Patent Application No. 62/533,610, filed Jul. 17, 2017, and U.S. Provisional Patent Application No. 62/539,703, filed Aug. 1, 2017, the contents of each of which are incorporated by reference herein.

### FIELD OF THE INVENTION

Embodiments of the invention are generally related to communication and processing of data within data processing systems. More particularly, embodiments of the invention relate to the communication and processing of wagering data within electronic gaming systems.

### BACKGROUND

The gaming industry has traditionally developed electronic gaming machines (EGMs) that implement simple chance-based wagering processes.

However, skill-based wagering processes need communication and processing systems that are better suited for implementing more complicated wagering processes. Various aspects of embodiments of the invention meet such a need.

### SUMMARY OF THE INVENTION

Systems and methods in accordance with embodiments of the invention provide a communication and data processing system constructed for a multiplayer variable skill objective interactive gaming system.

In an embodiment, a multiplayer variable skill objective electronic gaming machine includes an interactive controller constructed to generate a multiplayer presentation based on a multiplayer wagering proposition, detect player interactions of two or more players with the multiplayer presentation, determine a multiplayer skill objective achievement based on the player interactions, and communicate the multiplayer skill objective achievement to the process controller. The process controller is operatively connected to the interactive controller, wherein the process controller is constructed to generate a chance-based outcome using a random number generator, receive the multiplayer skill objective achievement for the multiplayer presentation from the interactive controller, and award the chance-based outcome to a player based on the multiplayer skill objective achievement.

In another embodiment, the interactive controller and the process controller are constructed from the same device.

In another embodiment, the process controller is operatively connected to the interactive controller using a communication link.

In another embodiment, the multiplayer variable skill objective electronic gaming machine further includes a credit processing controller, and an enclosure constructed to mount a user input device operatively connected to the interactive controller, a user output device operatively connected to the interactive controller, a credit input device operatively connected to the credit processing controller, and a credit output device operatively connected to the credit processing controller

In another embodiment, the process controller is further constructed to communicate with the credit input device to receive a credit input, credit a credit meter with credits based on the incoming credit data, update the credit meter based on the skill objective achievement of the wager, and communicate with the credit output device to generate a credit output based on credits transferred off of the credit meter.

In another embodiment, a multiplayer variable skill objective electronic gaming machine includes an enclosure constructed to mount a user input device, a user output device, a credit input device, a credit output device, at least one processor operatively connected to the user input device, the user output device, the credit input device, and the credit output device, and a memory operatively connected to the at least one processor. The memory stores processor executable instructions that when executed by the processor cause the processor to communicate with the credit input device to receive a credit input, credit a credit meter with credits based on the credit data, generate a chance-based outcome using a random number generator, generate a multiplayer presentation based on a multiplayer wagering proposition, detect player interactions of two or more players with the multiplayer presentation, determine a multiplayer skill objective achievement based on the player interactions, award the chance-based outcome to a player based on the multiplayer skill objective achievement, update the credit meter based on the skill objective achievement, and communicate with the credit output device to generate a credit output based on credits transferred off of the credit meter.

In another embodiment, the multiplayer presentation includes a skill disruptor generated in the multiplayer presentation during a player's skillful play of the multiplayer presentation.

In some embodiments, a process controller operates as an interface between an interactive controller that determines skill objective achievements and a wagering sub-controller that determines random outcomes. By virtue of this feature, the wagering sub-controller is isolated from the interactive controller allowing the interactive controller to operate in an unregulated environment while allowing the wagering sub-controller to operate in a regulated environment, thus providing for more efficient management of the operations of such a system.

In another embodiment of the invention, a single wagering sub-controller may provide services to two or more interactive controllers, thus allowing a multiplayer variable skill objective interactive gaming system to operate more efficiently over a large range of scaling.

In another embodiment of the invention, multiple types of interactive controllers using different operating systems may be interfaced to a single type of process controller without requiring customization of the process controller and/or the wagering sub-controller, thus improving the efficiency of the process controller and/or the wagering sub-controller by reducing complexity associated with maintaining separate process controllers and/or wagering sub-controllers for each type of interactive controller.

In another embodiment of the invention, an interactive controller may be provided as a player device under control of a player while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the multiplayer variable skill objective interactive gaming system.

In another embodiment of the invention, a process controller isolates random outcome logic and variable skill objective logic as unregulated logic from a regulated wagering sub-controller, thus allowing errors in the variable skill objective logic and/or random outcome logic to be corrected, new variable skill objective logic and/or random outcome logic to be used, or modifications to be made to the variable skill objective logic and/or random outcome logic without a need for time-consuming regulatory approval.

In another embodiment of the invention, a multiplayer interactive application may require extensive processing resources from an interactive controller leaving few processing resources for the functions performed by a process controller and/or a wagering sub-controller. By virtue of an architecture of some embodiments of the invention, processing loads may be distributed across multiple devices such that operations of the interactive controller may be dedicated to a multiplayer interactive application and the processes of the process controller and/or wagering sub-controller are not burdened by the requirements of the multiplayer interactive application.

In another embodiment of the invention, a multiplayer variable skill objective interactive gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of a multiplayer variable skill objective interactive gaming system are distributed in close proximity to each other and communicate using a local area network and/or a communication bus. In several embodiments, an interactive controller and a process controller of a multiplayer variable skill objective interactive gaming system are in a common location. In some embodiments, a process controller communicates with an external interactive controller. In various embodiments, these multiple controllers and sub-controllers can be constructed from or configured using a single device or a plurality of devices such that a multiplayer variable skill objective interactive gaming system is executed as a system in a virtualized space such as, but not limited to, where a wagering sub-controller and a process controller are large scale centralized servers and are operatively connected to distributed interactive controllers via a wide area network such as the Internet or a local area network. In such embodiments, the components of a multiplayer variable skill objective interactive gaming system may communicate using a networking protocol or other type of device-to-device communications protocol.

In another embodiment of the invention, an interactive controller is an interactive server acting as a host for managing head-to-head player interactions over a network of interactive sub-controllers connected to the interactive server using a communication link. The interactive server provides an environment where players or players can compete directly with one another and interact with other players or players.

### BRIEF DESCRIPTION OF THE DRAWINGS

FIG. 1 is a diagram of a structure of a multiplayer variable skill objective interactive gaming system in accordance with various embodiments of the invention.

FIG. 2A is a diagram of an electronic gaming machine configuration of a multiplayer variable skill objective interactive gaming system in accordance with various embodiments of the invention.

FIG. 2B is a diagram of a table electronic gaming machine configuration of a multiplayer variable skill objective interactive gaming system in accordance with various embodiments of the invention.

FIG. 2C is a diagram of a virtual reality gaming machine configuration of a multiplayer variable skill objective interactive gaming system in accordance with various embodiments of the invention.

FIG. 3 is a diagram of distributed multiplayer variable skill objective interactive gaming systems in accordance with various embodiments of the invention.

FIGS. 4A and 4B are diagrams of a structure of an interactive controller of a multiplayer variable skill objective interactive gaming system in accordance with various embodiments of the invention.

FIG. 5 is a diagram of a structure of a process controller of a multiplayer variable skill objective interactive gaming system in accordance with various embodiments of the invention.

FIG. 6 is a diagram of a structure of a credit processing controller of a multiplayer variable skill objective interactive gaming system in accordance with various embodiments of the invention.

FIG. 7 is a block diagram of a process of a multiplayer variable skill objective interactive gaming system in accordance with various embodiments of the invention.

FIG. 8 is a sequence diagram of interactions between components of a multiplayer variable skill objective interactive gaming system in accordance with various embodiments of the invention.

FIG. 9 is a state diagram illustrating another wagering process of a multiplayer variable skill objective interactive gaming system in accordance with various embodiments of the invention.

FIG. 10 is a state diagram illustrating another wagering process of a multiplayer variable skill objective interactive gaming system in accordance with various embodiments of the invention.

FIG. 11 is a state diagram illustrating another wagering process of a multiplayer variable skill objective interactive gaming system in accordance with various embodiments of the invention.

FIG. 12 is an activity diagram of a skill equalizing process of a multiplayer variable skill objective wagering system in accordance with various embodiments of the invention.

FIGS. 13A and 13B are state diagrams illustrating a wagering process having an auxiliary objective of a multiplayer variable skill objective interactive gaming system in accordance with various embodiments of the invention.

FIG. 14 is a data flow diagram of an auxiliary objective wagering process of a multiplayer variable skill objective interactive gaming system in accordance with various embodiments of the invention.

FIGS. 15A to 15D are illustrations of a user interface of a multiplayer variable skill objective interactive gaming system in accordance with various embodiments of the invention.

### DETAILED DESCRIPTION

A multiplayer variable skill objective interactive gaming system allows for the management of a wagering proposition having a multiplayer wagering proposition for two or more players where the multiplayer wagering proposition has one or more variable skill objectives generated in accordance with a random outcome and presented to at least one of the two or more players. In some embodiments of a multiplayer variable skill objective interactive gaming system, a multiplayer interactive application executed by an interactive controller provides multiplayer skill objective components of the multiplayer variable skill objective interactive gaming system. The interactive controller is operatively connected to a process controller that manages and configures the interactive controller and the multiplayer interactive application, and determines multiplayer wagering propositions having variable skill objectives determined by a wagering sub-controller that are resolved as skill objective achievements determined by the multiplayer interactive application.

In some embodiments, the interactive controller also provides a wagering user interface that is used to receive commands and display data for a wagering process and wagering outcome determined from the skill objective achievement in accordance with a wagering proposition. The content of the wagering user interface is controlled by the process controller and includes content provided by the wagering sub-controller and the interactive controller.

In various embodiments, an interactive controller provides a management user interface used to manage a player profile.

Many different types of multiplayer interactive applications may be utilized with the multiplayer variable skill objective interactive gaming system. In some embodiments, the multiplayer interactive application reacts to the physical activity of a player. In these embodiments, the multiplayer interactive application senses player interactions with the multiplayer interactive application through one or more sensors that monitor the player's physical activities. Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors.

In some embodiments, the multiplayer interactive application implements a multiplayer skill-based game and interacts with the player by sensing skillful interactions with an interactive user interface generated by the multiplayer interactive application.

In many embodiments, the multiplayer interactive application generates various types of interactive elements in a multiplayer interactive application environment. In some embodiments, these interactive elements are multiplayer interactive application resources utilized within the multiplayer interactive application environment to provide an interactive experience for a player.

In various embodiments, the wagers may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the multiplayer interactive application, application credits can be optionally consumed and/or accrued within the multiplayer interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based multiplayer interactive application. The skill-based multiplayer interactive application can have one or more scoring criteria, embedded within a process controller and/or an interactive controller that provides the skill-based multiplayer interactive application, that can be used to determine player performance against one or more goals of the skill-based multiplayer interactive application in accordance with a multiplayer wagering proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, a wagering proposition includes a wager of application credits for payout of application credits, multiplayer interactive application elements, and/or multiplayer interactive application objects.

In a number of embodiments, a wager of an amount of credits results in a payout of application credits, interactive elements, and/or multiplayer interactive application objects that have a credit value if cashed out.

In some embodiments, multiplayer interactive application objects include in-application objects that may be utilized to enhance player interactions with the multiplayer interactive application. Such objects include, but are not limited to, power-ups, enhanced in-application items, and the like. In some embodiments, the multiplayer interactive application objects include objects that are detrimental to player interactions with the multiplayer interactive application such as, but not limited to, obstructions in the multiplayer interactive application space, a temporary handicap, an enhanced opponent, and the like.

In numerous embodiments, a multiplayer interactive application command is an instruction by a process controller to an interactive controller and/or a multiplayer interactive application of the interactive controller to modify a state of a multiplayer interactive application or modify one or more multiplayer interactive application resources or interactive elements. In some embodiments, the multiplayer interactive application commands may be automatically generated by the process controller using one or more of a random outcome and/or application environment variables. A multiplayer interactive application command can be used by a process controller control many processes of a multiplayer interactive application, such as, but not limited to, an causing an addition of a period of time available for a current multiplayer interactive application session for the multiplayer interactive application, an addition of a period of time available for a future multiplayer variable skill objective interactive gaming system multiplayer interactive application session or any other modification to the multiplayer interactive application interactive elements that can be utilized during a multiplayer interactive application session.

In some embodiments, asynchronous communications provided for by a multiplayer variable skill objective interactive gaming system may reduce an amount of idle waiting time by an interactive controller of the multiplayer variable skill objective interactive gaming system, thus increasing an amount of processing resources that the interactive controller may provide to a multiplayer interactive application or other processes of the interactive controller. In many embodiments, asynchronous communications provided for by a multiplayer variable skill objective interactive gaming system reduces an amount of idle waiting time by a process controller, thus increasing an amount of processing resources that the process controller may provide to determine random outcomes, and other processes provided by the process controller.

In some embodiments, a wagering sub-controller of a multiplayer variable skill objective interactive gaming system may be operatively connected to a plurality of interactive controllers through a process controller and the asynchronous communications provided for by the process controller allows the wagering sub-controller to operate more efficiently by providing skill objectives to a larger number of interactive controllers than would be achievable without the process controller of the multiplayer variable skill objective interactive gaming system.

In some embodiments, a multiplayer variable skill objective interactive gaming system including a process controller operatively connected to a wagering sub-controller and operatively connected to an interactive controller wherein the process controller provides for simplified communication protocols for communications of the interactive controller as the interactive controller may communicate interactions with a multiplayer interactive application provided by the interactive controller to the process controller without regard to a nature of a skill objective.

In various embodiments, a multiplayer variable skill objective interactive gaming system including a process controller operatively connected to a wagering sub-controller and operatively connected to an interactive controller may provide for simplified communication protocols for communications of the wagering sub-controller as the wagering sub-controller may receive multiplayer wagering proposition requests and communicate determined multiplayer wagering propositions having skill objectives without regard to a nature of a multiplayer interactive application provided by the interactive controller.

In some embodiments, a multiplayer variable skill objective interactive gaming system including a process controller operatively connecting a wagering sub-controller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, a multiplayer variable skill objective interactive gaming system including a process controller operatively connecting a wagering sub-controller to an interactive controller provides for operation of the interactive controller in an unsecure location or manner, while providing for operation of the wagering sub-controller in a secure location or manner.

In some embodiments, a multiplayer variable skill objective interactive gaming system including a process controller operatively connecting a wagering sub-controller to an interactive controller allows the multiplayer variable skill objective interactive gaming system to have regulated components coupled to unregulated components in a heterogeneous regulated environment. For example, in several such embodiments, the interactive controller may be a device that is not regulated by a wagering regulatory agency whereas the wagering sub-controller is regulated by the wagering regulatory agency. A process controller of a multiplayer variable skill objective interactive gaming system may provide for isolation of the processing of the interactive controller from the processing of the wagering sub-controller. In such a heterogeneous regulatory environment, the process controller may or may not be itself a regulated by the wagering regulatory authority. In addition, components of a multiplayer interactive application executed by the interactive controller may be either regulated or unregulated by the wagering regulatory agency.

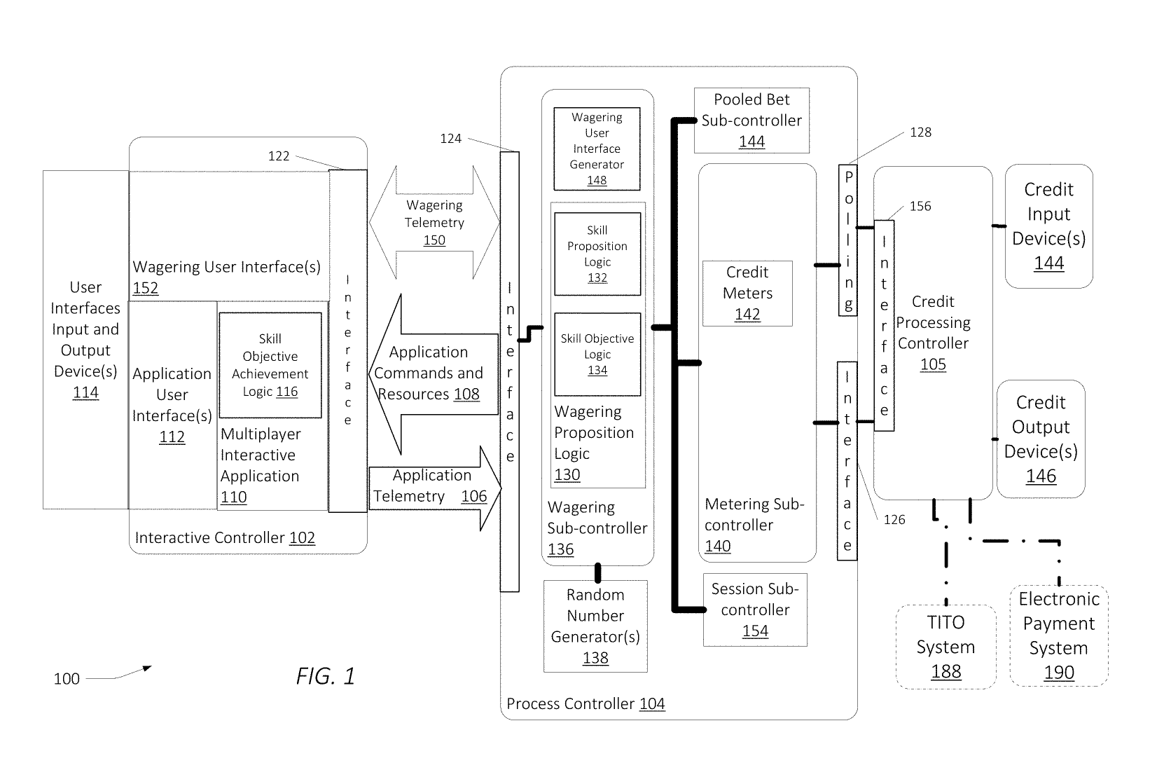

FIG. 1 is a diagram of a structure of a multiplayer variable skill objective interactive gaming system in accordance with various embodiments of the invention. The multiplayer variable skill objective interactive gaming system 100 includes an interactive controller 102, a process controller 104, and a credit processing controller 105. The interactive controller 102 is operatively connected to, and communicates with, the process controller 104. The process controller 104 is also operatively connected to, and communicates with, the credit processing controller 105.

In various embodiments, the interactive controller 102 executes a multiplayer interactive application 110 and provides one or more user interface input and output devices 114 so that two or more players can interact with the multiplayer interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the multiplayer interactive application 110 by executing the multiplayer interactive application 110 that generates an application user interface 112 that utilizes the user interface input devices to detect player interactions with the interactive controller 102 and generates an interactive user interface that is presented to the player utilizing the user interface output devices.

In some embodiments, one or more components an interactive controller are housed in an enclosure such as a housing, cabinet, casing or the like. The enclosure further includes one or more player accessible openings or surfaces that constructed to mount the user interface input devices and/or the user interface output devices.

The interactive controller 102 is operatively connected to, and communicates with, the process controller 104. The interactive controller 102 receives application command and resource data 108 including multiplayer wagering proposition data, application command data, and resource data, from the process controller 104. Via the communication of the application command and resource data 108, the process controller 104 can control the operation of the interactive controller 102 by communicating control parameters to the multiplayer interactive application 110 during the multiplayer interactive application's execution by the interactive controller 102.

In some embodiments, during execution of the multiplayer interactive application 110 by the interactive controller 102, the interactive controller 102 communicates, as application telemetry data 106, player interactions with one or more interactive elements of the application user interfaces 112 of the multiplayer interactive application to the process controller 104. The application telemetry data 106 may include, but is not limited to, application environment variables that indicate the state of the multiplayer interactive application 110, interactive controller data indicating a state of the interactive controller 102, player actions and interactions between two or more players and the multiplayer interactive application 110 provided by the interactive controller 102, and utilization of interactive elements in the multiplayer interactive application 110 by two or more players.

In some embodiments, the application telemetry 106 includes a skill objective achievement as determined by the multiplayer interactive application 110 using skill objective achievement logic 116, the application command and resource data 108, and player interactions with one or more application user interfaces 112 of the multiplayer interactive application.

In some embodiments, the multiplayer interactive application 110 is a skill-based multiplayer interactive application such as a skill-based game. In such embodiments, execution of the skill-based multiplayer interactive application 110 by the interactive controller 102 is based in part on two or more players' skillful interaction with the multiplayer interactive application 110, such as, but not limited to, the players' utilization of the interactive elements of the multiplayer interactive application during the players' skillful interaction with the skill-based multiplayer interactive application. In such an embodiment, the process controller 104 communicates with the interactive controller 102 in order to allow the coupling of the skill-based multiplayer interactive application to skill objectives determined in accordance with a multiplayer wagering proposition determined by the wagering sub-controller 136.

In some embodiments, the multiplayer interactive application 110 uses multiplayer wagering proposition data, multiplayer interactive application command data, and/or resource data included in the application commands and resources 108 to generate a multiplayer wagering proposition presented to two or more players as one or more application user interfaces 112 using one or more output devices of user interface and output device(s) 114. The two or more players skillfully interact with the one or more application user interfaces 112 using one or more of input devices of the user interface input and output devices 114. The multiplayer interactive application 110 determines a skill objective achievement based on the skillful interactions of the two or more players and communicates data of the determined skill objective achievement to the process controller 104 as part of the application telemetry 106. In some embodiments, the multiplayer interactive application 110 also communicates as part of the application telemetry data 106, data encoding the two or more players' interactions with the multiplayer interactive application 110.

In some embodiments, the skill objective achievement logic 116 and the multiplayer wagering proposition data included in the application commands and resources 108 are for a multiplayer wagering proposition for two or more players. The multiplayer interactive application 110 determines skill objective achievements based on the multiplayer wagering proposition and the two or more players' skillful interactions with the multiplayer interactive application. The skill objective achievements are communicated by the interactive controller 102 to the process controller 104 included in the application telemetry 106.

In some embodiments, the interactive controller 102 includes one or more sensors that sense various aspects of the physical environment of the interactive controller 102. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes one or more wagering user interfaces 118 used to display wagering data, via one or more of the user interface input and output devices 114, to two or more players.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the multiplayer interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a multiplayer wagering proposition resolved for two or more players when skillfully interacting with the multiplayer interactive application 110 provided by the interactive controller 102, and a skill objective, provided in-part by a wagering sub-controller 136.

In various embodiments, the process controller 104 includes a wagering sub-controller 136 having a rule-based decision engine that receives application telemetry data 106 from the interactive controller 102. The rule-based decision engine has wagering proposition logic 130 including multiplayer wagering proposition logic 132 and skill objective logic 134. The decision engine uses the application telemetry data 106, along with skill objective logic 134, and one or more random outcomes generated by one or more random number generators (RNGs) 138 to generate a skill objective of a multiplayer wagering proposition.

In an embodiment, the application telemetry data 106 used by the decision engine encodes data about the operation of the multiplayer interactive application 110 executed by the interactive controller 102.

In some embodiments, the application telemetry data 106 encodes interactions of a player, such as a player's interaction with an interactive element of the multiplayer interactive application 110.

In many embodiments, the application telemetry data 106 includes a state of the multiplayer interactive application 110, such as values of variables that change as the multiplayer interactive application 110 executes.

In several embodiments, the decision engine includes one or more rules as part of skill objective logic 134 used by the decision engine 122 to determine how a skill objective should generated. Each rule includes one or more variable values constituting a pattern that is to be matched by the wagering sub-controller 136 using the decision engine to one or more variable values encoded in the application telemetry data 106. Each rule also includes one or more actions that are to be taken if the pattern is matched. Actions can include automatically generating the skill objective in accordance with the skill objective logic 134 and a random outcome generated by one or more random number generators 138. During operation, the decision engine receives application telemetry data 106 from the interactive controller 102 via interface 160. The decision engine performs a matching process of matching the variable values encoded in the application telemetry data 106 to one or more variable patterns of one or more rules. If a match between the variable values and a pattern of a rule is determined, then the wagering controller 104 performs the action of the matched rule.

In some embodiments, the wagering sub-controller 136 uses the skill objective in conjunction with the application telemetry data 106 and multiplayer wagering proposition logic 132, to automatically generate application command and resource data 108 including multiplayer wagering proposition data of a multiplayer wagering proposition that the process controller 104 communicates to the interactive controller 102 via interfaces 124 and 122.

In some embodiments, the decision engine includes one or more rules as part of multiplayer wagering proposition logic 132 used by the decision engine to automatically generate the application command and resource data 108 that is then communicated to the interactive controller 102. Each rule includes one or more variable values constituting a pattern that is to be matched to one or more variable values encoded in the application telemetry data 106 and the skill objective. Each rule also includes one or more actions that are to be automatically taken by the wagering sub-controller 136 if the pattern is matched. Actions can include automatically generating multiplayer wagering proposition data, multiplayer interactive application command data, and/or resource data 108 and using the multiplayer wagering proposition data, multiplayer interactive application command data, and/or resource data 108 to control the interactive controller 102 to affect execution of the multiplayer interactive application 110 as described herein. In operation, wagering sub-controller 104 uses the decision engine 122 to match the variable values encoded in the in the skill objective data to one or more patterns of one or more rules of the multiplayer wagering proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the skill objective to generate the multiplayer wagering proposition data, multiplayer interactive application command data, and/or resource data 108.

The interactive controller receives the multiplayer wagering proposition data, multiplayer interactive application command data, and resource data 108 and automatically uses the multiplayer wagering proposition data, multiplayer interactive application command data, and/or resource data 108 to configure and command the processes of the multiplayer interactive application 110.

In some embodiments, the multiplayer interactive application 110 operates utilizing a scripting language. The multiplayer interactive application 110 parses scripts written in the scripting language and executes commands encoded in the scripts and sets variable values as defined in the scripts. In operation of such embodiments, the process controller 104 automatically generates multiplayer wagering proposition data, multiplayer interactive application command data, and/or resource data 108 in the form of scripts written in the scripting language that are communicated to the interactive controller 102 during execution of the multiplayer interactive application 110. The interactive controller 102 receives the scripts and passes them to the multiplayer interactive application 110. The multiplayer interactive application 110 receives the scripts, parses the scripts and automatically executes the commands and sets the variable values as encoded in the scripts.

In many embodiments, the multiplayer interactive application 110 automatically performs processes as instructed by commands communicated from the process controller 104. The commands command the multiplayer interactive application 110 to perform specified operations such as executing specified commands and/or setting the values of variables utilized by the multiplayer interactive application 110. In operation of such embodiments, the process controller 104 automatically generates commands that are encoded into the multiplayer wagering proposition data, multiplayer interactive application command data, and/or resource data 108 that are communicated to the interactive controller 102. The interactive controller 102 passes the multiplayer wagering proposition data, multiplayer interactive application command data, and/or resource data 108 to the multiplayer interactive application 110. The multiplayer interactive application parses the multiplayer wagering proposition data, multiplayer interactive application command data, and/or resource data and automatically performs operations in accordance with the commands encoded in the multiplayer wagering proposition data, multiplayer interactive application command data, and/or resource data 108.

In many embodiments, the process controller 104 includes a random number generator used to generate random outcomes that are used by the decision engine to generate portions of the multiplayer wagering proposition data, multiplayer interactive application command data, and/or resource data 108.

In various embodiments, the process controller 104 includes one or more interfaces, 124, 126 and 128 that operatively connect the process controller 104 to one or more interactive controllers, such as interactive controller 102, and to one or more credit processing controllers, such as credit processing controller 105.

In some embodiments, one or more of the process controller interfaces implement a process controller to device or server communication protocol employing an interprocess communication protocol so that the process controller and one or more of an interactive controller, a wagering sub-controller, and/or a session sub-controller may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive controllers, the one or more session sub-controllers and/or the one or more wagering sub-controllers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive controllers, the one or more session sub-controllers, and/or the one or more wagering sub-controllers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In several embodiments, the wagering sub-controller 136 is a controller for providing one or more wagers in accordance with one or more multiplayer wagering propositions provided by the multiplayer variable skill objective interactive gaming system 100. Types of value of a wager can be one or more of several different types. Types of value of a wager can include, but are not limited to, a wager of an amount of credits corresponding to a real currency or a virtual currency, a wager of an amount of application credits earned through interaction with a multiplayer interactive application, a wager of an amount of interactive elements of a multiplayer interactive application, and a wager of an amount of objects used in a multiplayer interactive application. A skill objective achievement determined for a wager in accordance with a multiplayer wagering proposition can increase or decrease an amount of the type of value used in the wager, such as, but not limited to, increasing or decreasing an amount of credits for a wager of credits. In various embodiments, a skill objective achievement determined for a wager in accordance with a multiplayer wagering proposition can increase or decrease an amount of a type of value that is different than a type of value of the wager, such as, but not limited to, increasing an amount of an object of a multiplayer interactive application for a wager of credits.

In many embodiments, the process controller 104 includes one or more random number generators (RNGs) 138 for generating random outcomes. The wagering sub-controller uses the one or more random outcomes along with the skill objective logic 130 to generate a skill objective of a multiplayer wagering proposition.

In several embodiments, the process controller 104 includes a metering sub-controller 140 operatively connected to the credit processing controller 105 via interfaces 126 and 128. The metering sub-controller 140 communicates with the credit processing controller 105 to receive incoming credit data from the credit processing controller 105. The metering sub-controller 140 uses the incoming credit data to transfer credits into the multiplayer variable skill objective interactive gaming system and onto one or more credit meters 142. The metering sub-controller 140 communicates outgoing credit data to the credit processing controller 105 to transfer credits off of the one or more credit meters 142 and out of the multiplayer variable skill objective interactive gaming system.

In several embodiments, during operation, the metering sub-controller 140 communicates with the credit processing controller 105 to receive incoming credit data from the credit processing controller 105 and adds credits onto the one or more credit meters 110 at least partially on the basis of the incoming credit data. The one or more random number generators 138 execute processes that generate cs. The wagering sub-controller 136 uses the change-based component logic 134 and the random outcomes to generate a skill objective of a multiplayer wagering proposition. The wagering sub-controller uses the skill objective along with the multiplayer wagering proposition logic 132 to generate a multiplayer wagering proposition. The multiplayer wagering proposition is communicated by the process controller as part of the application command and resource data 108 to the interactive controller 102. The multiplayer interactive application 110 uses the multiplayer wagering proposition data along with the skill objective achievement logic 116 to generate a presentation for the user including the one or more user interfaces 112. Two or more players interact with the one or more application user interfaces 112 through the one or more user interface input and output devices 114. The multiplayer interactive application 110 determines a skill objective achievement based on the interactions of the two or more players and communicates data of the skill objective achievement as part of the application telemetry data 106 to the process controller 104. The wagering sub controller 136 receives the skill objective achievement data and instructs the metering sub-controller 140 to add credits to, or deduct credits from, the one or more credit meters 110 based in part on the skill objective achievement data. For example, in some embodiments, the metering sub-controller is instructed to add an amount of credits to a credit meter of the one or more credit meters 110 when the skill objective achievement indicates a win for a player associated with the credit meter. In various embodiments, the metering sub-controller is instructed to deduct an amount of credits from the credit meter when the skill objective achievement indicates a loss for the player. At an end of a wagering session, the metering sub-controller 140 transfers credits off of the one or more credit meters 110 and out of the multiplayer variable skill objective interactive gaming system by communicating outgoing credit data to the credit processing controller 105.

In many embodiments, the one or more random number generators 138 generate random numbers by continuously generating pseudo random numbers using a pseudo random number generator. A most current pseudo random number is stored in a buffer thus constantly refreshing the buffer. In many embodiments, the buffer is refreshed at a rate exceeding 100 times per second. When the wagering sub-controller 136 requests a random outcome, the wagering sub-controller 136 receives the stored most current pseudo random number from the buffer. As timing between requests for a random outcome is not deterministic, the resulting output from the buffer is a random outcome such as a random number.

In some embodiments, a wagering sub-controller determines a skill objective and a multiplayer wagering proposition by executing proposition determination commands included in skill objective logic and multiplayer wagering proposition logic that define processes of a wagering proposition where the proposition determination commands are formatted in a scripting language. In operation, a decision engine of a process controller generates the proposition determination commands in the form of a script written in the scripting language. The script includes the proposition determination commands that describe how the wagering sub-controller is to generate a multiplayer wagering proposition. The wagering sub-controller parses the script encoded in the chance proposition determination command data and executes the commands included in the script to generate the multiplayer wagering proposition.

In some embodiments, a wagering sub-controller determines a skill objective and a multiplayer wagering proposition by executing proposition determination commands that define processes of the wagering user interface. In operation, a decision engine of a process controller generates the proposition determination commands. The wagering sub-controller receives the proposition determination commands and executes the proposition determination commands to generate the multiplayer wagering proposition.

In various embodiments, the process controller 104 uses a rule-based decision engine to automatically determine an amount of application credits to award to a player based at least in part on the application telemetry data 106 including skill objective achievement data and player interaction data with the multiplayer interactive application 110 of the multiplayer variable skill objective interactive gaming system. In numerous embodiments, the multiplayer interactive application 110 is a skill-based multiplayer interactive application and the application credits are awarded for a player's skillful interaction with the multiplayer interactive application 110.

In some embodiments, the wagering sub-controller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and loss for the multiplayer variable skill objective interactive gaming system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the multiplayer interactive application 110, and credits, application credits and interactive elements amounts won, lost or accumulated.

In some embodiments, the multiplayer wagering proposition data, multiplayer interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives skill objective data that is used as a partial basis for generation of the wagering telemetry data 150 communicated to the interactive controller 102. In some embodiments, the skill objective data also includes data about one or more states of a wager of the multiplayer wagering proposition as generated by the wagering sub-controller 136. In various such embodiments, the wagering user interface generator 148 generates a skill objective generation process display and/or skill objective state display using the one or more states of the skill objective. The skill objective generation process display and/or skill objective state display is included in the wagering telemetry data 150 that is communicated to the interactive controller 102. The wagering process display and/or wagering state display is automatically displayed by the interactive controller 102 using the one or more wagering user interfaces 152. In other such embodiments, the one or more states of the skill objective are communicated to the interactive controller 102 and the interactive controller 102 is instructed to automatically generate the skill objective generation process display and/or skill objective state display of the one or more wagering user interfaces 152 using the one or more states of the skill objective for display.

In some embodiments, the skill objective includes state data about execution of a multiplayer wagering proposition of the skill objective logic 134, including but not limited to a final state, intermediate state and/or beginning state of the chance-based proposition. For example, in a chance-based proposition that is based on slot machine math, the final state of the chance-based proposition may be reel positions, in a chance-based proposition that is based on roulette wheel math, the final state may be a pocket where a ball may have come to rest, in a chance-based proposition that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wagering outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wagering outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering sub-controller to determine an amount of credit or interactive elements available and other wagering metrics of a wagering proposition. Thus, the process controller 104 may potentially affect an amount of credits in play for participation in the wagering events of the wagering proposition provided by the wagering sub-controller. In some embodiments, the process controller 104 can also couple to a centralized server for exchanging various data related to players or players and the activities of the players or players during utilization of a multiplayer variable skill objective interactive gaming system.

In a number of embodiments, communication of skill objective determination commands and multiplayer wagering proposition commands between the wagering sub-controller 136 and the process controller 104 can further be used to communicate various wagering control factors that the wagering sub-controller uses as input. Examples of wagering control factors include, but are not limited to, an amount of credits, amount of application credits, amount of interactive elements, or amounts of objects consumed wager, and/or a player's election to enter a jackpot round.

In many embodiments, two or more players or players can be engaged in using the multiplayer interactive application 110 executed by the interactive controller 102. In various embodiments, a multiplayer variable skill objective interactive gaming system can include a multiplayer interactive application 110 that provides a skill-based multiplayer interactive application that includes head-to-head play between a single player and a computing device, between two or more players or players against one another, or multiple players or players playing against a computer device and/or each other. In some embodiments, the multiplayer interactive application 110 can be a skill-based multiplayer interactive application where the player is not skillfully playing against the computer or any other player such as skill-based multiplayer interactive applications where the player is effectively skillfully playing against himself or herself.

In some embodiments, the process controller 104 utilizes the one or more wagering user interfaces 152 to communicate certain multiplayer interactive application data to the player, including but not limited to, club points, player status, control of the selection of choices, and messages which a player can find useful in order to adjust the multiplayer interactive application experience or understand the wagering status of the player.

In some embodiments, the process controller 104 utilizes the one or more wagering user interfaces 152 to communicate aspects of a wagering proposition to a player including, but not limited to, amount of credits, application credits, interactive elements, or objects in play, and amounts of credits, application credits, interactive elements, or objects available.

In a number of embodiments, the wagering sub-controller 136 can accept wagering proposition factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering sub-controller, such that an increase/decrease in a wagered amount can be related to the change in player profile of the player in the multiplayer interactive application. In this manner, a player can control a wager amount per wagering event in accordance with the wagering proposition with the change mapping to a parameter or component that is applicable to the multiplayer interactive application experience.

In some embodiments, the process controller 104 includes a session sub-controller 154 is used to regulate a multiplayer variable skill objective interactive gaming system session.

In various embodiments, the session sub-controller 154 includes one or more session sub-controller interfaces that operatively connect the session sub-controller 154 to one or more wagering sub-controllers, metering sub-controllers and pooled bet sub-controllers through their respective interfaces.

In some embodiments, one or more of the session sub-controller interfaces implement a session sub-controller to device or server communication protocol employing an interprocess communication protocol so that the session sub-controller and one or more of an interactive controller, a wagering sub-controller, and/or a process controller may be implemented on the same device. In operation, the session sub-controller interfaces provide application programming interfaces or the like that are used by the session sub-controller to communicate outgoing data and receive incoming data by passing parameter data to another process or application running on the same device.

In some embodiments, one or more of the session sub-controller interfaces implement a session sub-controller communication protocol employing an interdevice communication protocol so that the session sub-controller may be implemented on a device separate from the one or more interactive controllers, the one or more process controllers and/or the one or more wagering sub-controllers. The interdevice protocol may utilize a wired communication bus or wireless connection as a physical layer. In various embodiments, one or more of the session sub-controller interfaces implement a session sub-controller communication protocol employing a networking protocol so that the process session sub-controller may be operatively connected to the one or more interactive controllers, the one or more process controllers, and/or the one or more wagering sub-controllers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more session sub-controller interfaces communicate outgoing data to an external device or server by encoding the data into a signal and transmitting the signal to the external device or server. The one or more session sub-controller interfaces receive incoming data from an external device or server by receiving a signal transmitted by the external device or server and decoding the signal to obtain the incoming data.

In various embodiments, components of the process controller 104 communicate session data to the session sub-controller. The session data may include, but is not limited to, player data, interactive controller data, pooled bet and side bet data, process controller data and wagering sub-controller data used by the session sub-controller to regulate a multiplayer variable skill objective interactive gaming system session.

In some embodiments, the session sub-controller 154 may also assert control of a multiplayer variable skill objective interactive gaming system session by communicating session control data to components of the process controller 104. Such control may include, but is not limited to, commanding the process controller 104 to end a multiplayer variable skill objective interactive gaming system session, initiating wagering in a multiplayer variable skill objective interactive gaming system session, ending wagering in a multiplayer variable skill objective interactive gaming system session but not ending a player's use of the multiplayer interactive application portion of the multiplayer variable skill objective interactive gaming system, and changing from real credit wagering in a multiplayer variable skill objective interactive gaming system to virtual credit wagering, or vice versa.

In many embodiments, the session sub-controller 154 manages player profiles for a plurality of players or players. The session sub-controller 154 stores and manages data about players or players in order to provide authentication and authorization of players or players of the multiplayer variable skill objective interactive gaming system 100. In some embodiments, the session sub-controller 154 also manages geolocation information to ensure that the multiplayer variable skill objective interactive gaming system 100 is only used by players or players in jurisdictions were wagering is approved. In various embodiments, the session sub-controller 154 stores application credits that are associated with the player's use of the multiplayer interactive application of the multiplayer variable skill objective interactive gaming system 100.

In some embodiments, the session sub-controller 154 communicates player and session management data to the player using a management user interface (not shown) of the interactive controller. The player interacts with the management user interface and the management user interface generates management telemetry data that is communicated to the session sub-controller 154 via interfaces 122 and 124.

In some embodiments, the wagering sub-controller 136 communicates wagering session data to the session sub-controller 154. In various embodiments, the session sub-controller communicates wagering session control data to the wagering sub-controller 136.

In some embodiments, a process controller operates as an interface between an interactive controller and a wagering sub-controller. By virtue of this construction, the wagering sub-controller is isolated from the interactive controller allowing the interactive controller to operate in an unregulated environment while allowing the wagering sub-controller to operate in a regulated environment.

In some embodiments, a single wagering sub-controller may provide services to two or more interactive controllers and/or two or more process controllers, thus allowing a multiplayer variable skill objective interactive gaming system to operate over a large range of scaling.

In various embodiments, multiple types of interactive controllers using different operating systems may be interfaced to a single type of process controller and/or wagering sub-controller without requiring customization of the process controller and/or the wagering sub-controller.

In many embodiments, an interactive controller may be provided as a player device under control of a player while maintaining the wagering sub-controller in an environment under the control of a regulated operator of wagering equipment.

In several embodiments, data communicated between the controllers may be encrypted to increase security of the multiplayer variable skill objective interactive gaming system.

In some embodiments, a process controller isolates skill objective logic and multiplayer wagering proposition logic as unregulated logic from a regulated wagering sub-controller, thus allowing errors in the multiplayer wagering proposition logic and/or skill objective logic to be corrected, new multiplayer wagering proposition logic and/or skill objective logic to be used, or modifications to be made to the multiplayer wagering proposition logic and/or skill objective logic without a need for regulatory approval.

In various embodiments, a multiplayer interactive application may require extensive processing resources from an interactive controller leaving few processing resources for the functions performed by a process controller and/or a wagering sub-controller. By virtue of the architecture described herein, processing loads may be distributed across multiple devices such that operations of the interactive controller may be dedicated to the multiplayer interactive application and the processes of the process controller and/or wagering sub-controller are not burdened by the requirements of the multiplayer interactive application.

In many embodiments, a multiplayer variable skill objective interactive gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a multiplayer variable skill objective interactive gaming system are distributed in close proximity to each other and communicate using a local area network and/or a communication bus. In several embodiments, an interactive controller and a process controller of a multiplayer variable skill objective interactive gaming system are in a common location and communicate with an external wagering sub-controller. In some embodiments, a process controller and a wagering sub-controller of a multiplayer variable skill objective interactive gaming system are in a common location and communicate with an external interactive controller. In many embodiments, an interactive controller, a process controller, and a wagering sub-controller of a multiplayer variable skill objective interactive gaming system are located in a common location. In some embodiments, a session sub-controller is located in a common location with a process controller and/or a wagering sub-controller.

In various embodiments, these multiple devices can be constructed from or configured using a single device or a plurality of devices such that a multiplayer variable skill objective interactive gaming system is executed as a system in a virtualized space such as, but not limited to, where a wagering sub-controller and a process controller are large scale centralized servers in the cloud operatively connected to widely distributed interactive controllers via a wide area network such as the Internet or a local area network. In such embodiments, the components of a multiplayer variable skill objective interactive gaming system may communicate using a networking protocol or other type of device-to-device communications protocol.

In some embodiments, a multiplayer variable skill objective interactive gaming system is deployed over a local area network or a wide area network in an interactive configuration. An interactive configuration of a multiplayer variable skill objective interactive gaming system includes an interactive controller operatively connected by a network to a process controller and a wagering sub-controller.

In some embodiments, a multiplayer variable skill objective interactive gaming system is deployed over a local area network or a wide area network in a mobile configuration. A mobile configuration of a multiplayer variable skill objective interactive gaming system is useful for deployment over wireless communication network, such as a wireless local area network or a wireless telecommunications network. A mobile configuration of a multiplayer variable skill objective interactive gaming system includes an interactive controller operatively connected by a wireless network to a process controller and a wagering sub-controller.

In several embodiments, a centralized process controller is operatively connected to one or more interactive controllers and one or more wagering sub-controllers using a communication link. The centralized process controller can perform the functionality of a process controller across various multiplayer variable skill objective interactive gaming systems.

In numerous embodiments, a multiplayer interactive application server provides a host for managing head-to-head play operating over a network of interactive controllers connected to the multiplayer interactive application server using a communication link. The multiplayer interactive application server provides an environment where players or players can compete directly with one another and interact with other players or players.

In many embodiments, the credit processing controller 105 operatively connects to one or more credit input devices for generating incoming credit data from a credit input. Credit inputs can include, but are not limited to, credit items used to transfer credits. The incoming credit data are communicated by the credit processing controller 105 to the metering sub-controller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing controller 105 includes one or more credit output devices 146 for generating a credit output based on outgoing credit data 192 communicated from the wagering sub-controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 105 is operatively connected to, and communicates with, a TITO system 188 or the like to determine incoming credit data representing amounts of credits to be transferred into the multiplayer variable skill objective interactive gaming system and to determine outgoing credit data representing amounts of credits to be transferred out of the multiplayer variable skill objective interactive gaming system. In operation, the credit processing controller 105 communicates with a connected credit input device, such as a bill validator/ticket scanner, used to scan a credit input in the form of a TITO ticket having indicia of credit account data of a credit account of the TITO system. The credit processing controller 105 communicates the credit account data to the TITO system. The TITO system uses the credit account data to determine an amount of credits to transfer to the credit processing controller 105, and thus to the metering sub-controller 140 of the process controller 104. The TITO system communicates the amount of credits to the credit processing controller 105. The credit processing controller 105 communicates the amount of credits as incoming credit data to the metering sub-controller 140 and the metering sub-controller 140 credits one or more credit meters 142 with the amount of credits so that the credits can be used when a player makes wagers using the multiplayer variable skill objective interactive gaming system 100.

In many embodiments, the credit processing controller 105 is operatively connected to a bill validator/ticket scanner as one of the one or more credit input devices 144. The credit processing controller 105 communicates with the bill validator/ticket scanner to scan currency used as a credit input to determine an amount of credits as incoming credit data to transfer credit to one or more credit meters 110 associated with two or more players. The skill metering sub-controller 140 credits the one or more credit meters 110 with the amount of credits so that the credits can be used when a player makes wagers using the multiplayer variable skill objective interactive gaming system 100.

In some embodiments, the credit processing controller 105 can use a TITO system along with a ticket or voucher printer as one of the one or more credit output devices 146 to generate a TITO ticket as a credit output for a player. In operation, the credit processing controller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 105. The credit processing controller 105 uses the ticket or voucher printer to print indicia of the credit account data onto a TITO ticket or voucher as a credit output.

In various embodiments, a credit processing interface 156 resident in the credit processing controller 105 provides an interface between the credit processing controller 156 and the process controller 104.

In some embodiments, the application control interface 122 implements a credit processing controller to process controller communication protocol employing an interprocess communication protocol so that the interactive controller 104 and the credit processing controller 105 may be implemented on the same device. In operation, the credit processing interface 156 provides application programming interfaces that are used by the credit processing controller 105 to communicate outgoing data and receive incoming data by passing parameter data to another process or application.

In some embodiments, the credit processing interface 156 implements an interactive controller to credit processing controller communication protocol employing an interdevice communication protocol so that the interactive controller and the credit processing controller may be implemented on different devices. The interdevice protocol may utilize a wired communication bus or wireless connection as a physical layer.

In various embodiments, the credit processing interface 156 implements an interactive controller to credit processing controller communication protocol employing a networking protocol so that the interactive controller 104 and the credit processing controller 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing controller 105 provides an interface to an electronic payment management system 190 such as an electronic wallet or the like. The electronic payment system provides credit account data that is used for generating incoming credit data as a credit input and outgoing credit data as a credit output.

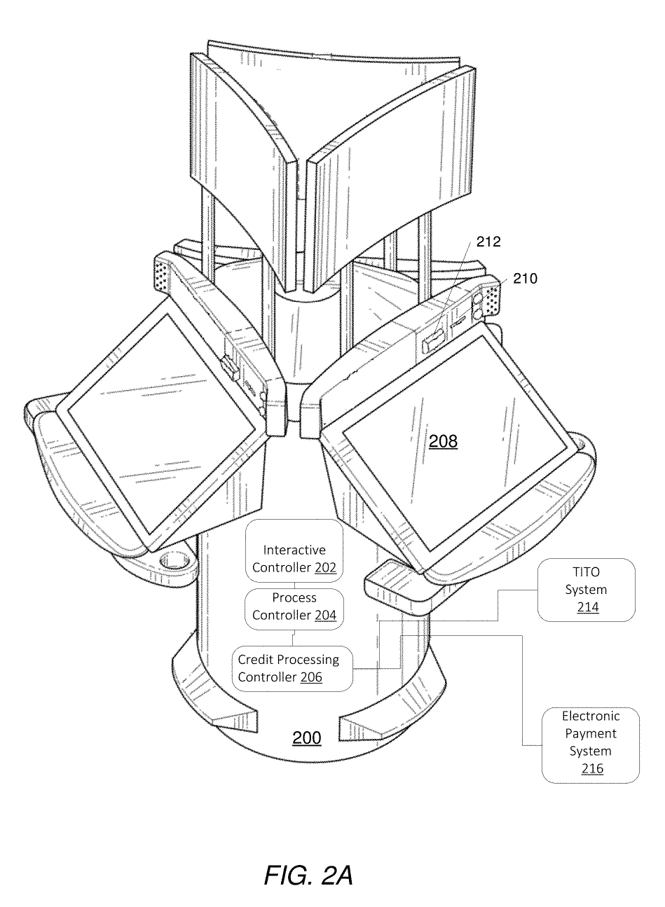

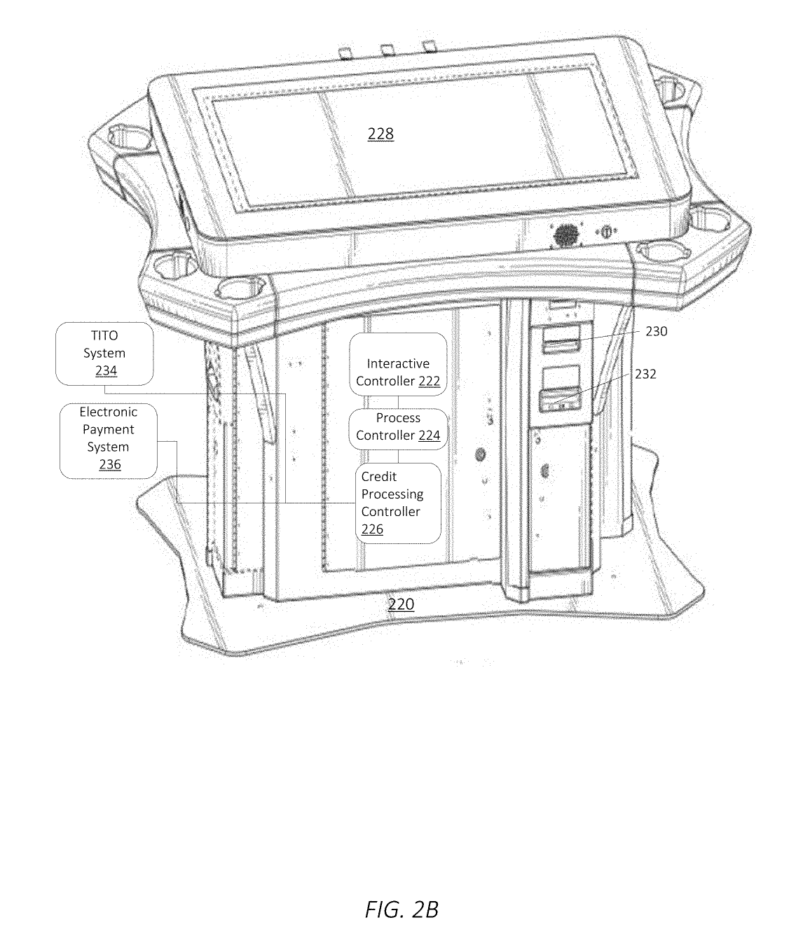

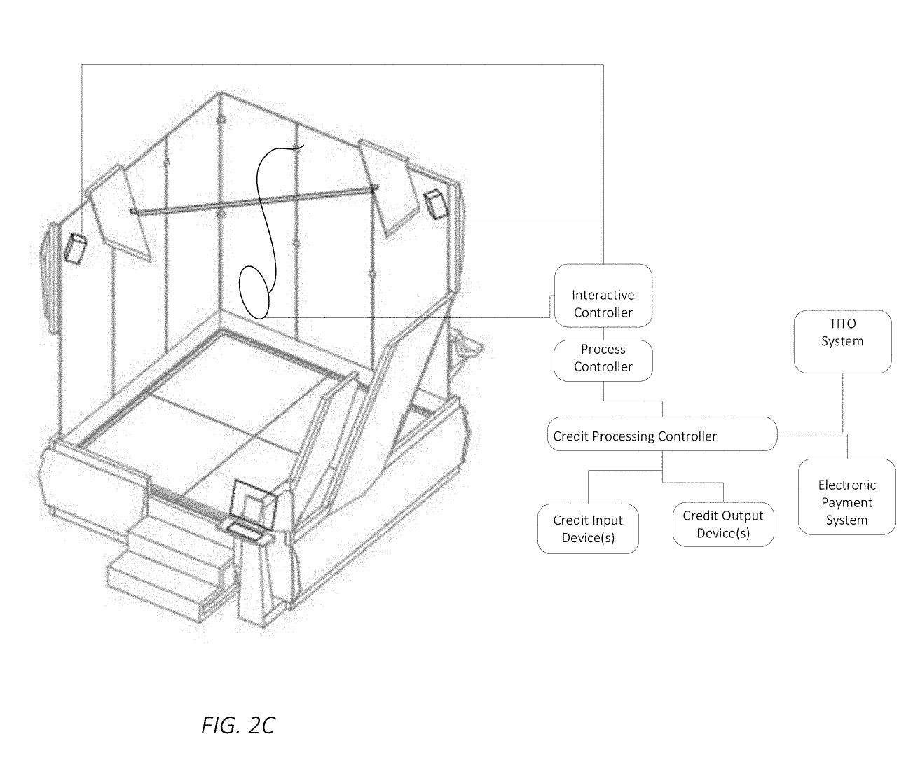

FIG. 2A is a diagram of an electronic gaming machine configuration of a multiplayer variable skill objective interactive gaming system in accordance with various embodiments of the invention. Electronic gaming machine configurations of a multiplayer variable skill objective interactive gaming system include, but are not limited to, electronic gaming machines such as slot machines, table games, video arcade consoles and the like. An electronic gaming machine configuration of a multiplayer variable skill objective interactive gaming system 200 includes an interactive controller 202, a process controller 204 and a credit processing controller 206 contained in an enclosure such as a housing, cabinet, casing or the like. The enclosure may further include one or more player accessible openings or surfaces that may be used to mount one or more player accessible user input devices and user output devices 208, one or more player accessible credit input devices 210 and one or more credit output devices 212. The interactive controller 202 communicates with the user input devices to detect player interactions with the multiplayer variable skill objective interactive gaming system and commands and controls the user output devices to provide a user interface to two or more players of the multiplayer variable skill objective interactive gaming system as described herein. The process controller 204 communicates with the credit processing controller 206 or player credit processing devices 210 and 212 to transfer credits into and out of the multiplayer variable skill objective interactive gaming system as described herein.

In many embodiments, the process controller 204 is operatively connected to an external session sub-controller (not shown). The session sub-controller may provide session control for a wagering session or may provide services for management of a player account for the storage of player points, application credits and the like.

In various embodiments, the process controller 204 is operatively connected to the credit processing controller 206. In many embodiments, the credit processing controller 206 is operatively connected to one or more credit input devices 210 for generating incoming credit data from a credit input as described herein. The incoming credit data are communicated to the process controller 204. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller 206 is operatively connected to the one or more credit output devices 212 for generating a credit output based on outgoing credit data communicated from the process controller 204. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 206 is operatively connected to, and communicates with, a TITO system 214 or the like to determine incoming credit data representing amounts of credits to be transferred into the multiplayer variable skill objective interactive gaming system 200 and to determine outgoing credit data representing amounts of credits to be transferred out of the multiplayer variable skill objective interactive gaming system 200. In operation, the credit processing controller 206 communicates with one of the one or more connected credit input devices 210, such as a bill validator/ticket scanner, used to scan a credit input in the form of a TITO ticket having indicia of credit account data of a credit account of the TITO system 214. The credit processing controller 206 communicates the credit account data to the TITO system 214. The TITO system 214 uses the credit account data to determine an amount of credits to transfer to the credit processing controller 206 of the multiplayer variable skill objective interactive gaming system 200. The TITO system 214 communicates the amount of credits to the credit processing controller 206. The credit processing controller 206 communicates the amount of credits as incoming credit data to the process controller 204 which credits one or more credit meters with the amount of credits so that the credits can be used when a player makes wagers using the multiplayer variable skill objective interactive gaming system 200.

In many embodiments, the credit processing controller 206 includes a bill validator/ticket scanner as one of the one or more credit input devices 210. The credit processing controller 206 communicates with the bill validator/ticket scanner to scan currency used as a credit input to determine an amount of credits as incoming credit data to transfer credit to one or more credit meters associated with two or more players. The process controller 204 credits the one or more credit meters with the amount of credits so that the credits can be used when a player makes wagers using the multiplayer variable skill objective interactive gaming system 200.

In some embodiments, the credit processing controller 206 can use the TITO system 214 along with a ticket or voucher printer as one of the one or more credit output devices 212 to generate a TITO ticket as a credit output for a player. In operation, the credit processing controller 206 communicates, as outgoing credit data, data of an amount of credits to be credited to a credit account on the TITO system 214. The TITO system 214 receives the amount of credits and creates the credit account and credits the credit account with the amount of credits. The TITO system 214 generates credit account data for the credit account and communicates the credit account data to the credit processing controller 206. The credit processing controller 206 uses the ticket or voucher printer to print indicia of the credit account data onto a TITO ticket as a credit output.

In various embodiments, the credit processing controller 206 provides an interface to an electronic payment system 216 such an electronic wallet or the like. The electronic payment system 216 provides credit account data that is used for generating incoming credit data as a credit input and outgoing credit data as a credit output.

In some embodiments, the process controller 204 is operatively connected to a central determination controller (not shown). In operation, when a wagering sub-controller of the process controller 204 needs to determine a random outcome, the wagering sub-controller communicates a request to the central determination controller for the random outcome. The central determination controller receives the random outcome request and generates a random outcome in response to the random outcome request. The central determination controller communicates data of the random outcome to the process controller 204. The processing controller 204 receives the data of the random outcome and utilizes the random outcome as described herein. In some embodiments, the random outcome is drawn from a pool of pre-determined random outcomes.

In various embodiments, the wagering process controller 204 may be operatively connected to a progressive controller along (not shown) with one or more other process controllers of one or more other multiplayer variable skill objective interactive gaming systems. The progressive controller provides services for the collection and provision of credits used by the process controller 204 to provide random outcomes that have a progressive or pooling component.

FIG. 2B is a diagram of multiplayer or multiplayer electronic gaming machine configuration of a multiplayer variable skill objective interactive gaming system in accordance with various embodiments of the invention. Types of a multiplayer or multiplayer electronic gaming machine configuration a multiplayer variable skill objective interactive gaming system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of a multiplayer variable skill objective interactive gaming system 220 includes an interactive controller 222, a process controller 224 and a credit processing controller 226 contained in an enclosure such as a housing, cabinet, casing or the like. The enclosure may further include one or more player accessible openings or surfaces that may be used to mount one or more player accessible user input devices and user output devices 228, one or more player accessible credit input devices 230 and one or more player accessible credit output devices 212.

In some embodiments, two or more sets of credit input devices and credit output devices are provided so that each player of the multiplayer or multiplayer electronic gaming machine configuration of a multiplayer variable skill objective interactive gaming system 220 can have an associated set of credit input devices and credit output devices.

The interactive controller 222 communicates with the user input devices to detect player interactions with the multiplayer variable skill objective interactive gaming system and commands and controls the user output devices to provide a user interface to two or more players of the multiplayer variable skill objective interactive gaming system as described herein. The process controller 224 communicates with the credit processing controller 226 or player credit processing devices 230 and 232 to transfer credits into and out of the multiplayer variable skill objective interactive gaming system as described herein.

In many embodiments, the process controller 224 is operatively connected to an external session sub-controller (not shown). The session sub-controller may provide session control for a wagering session or may provide services for management of a player account for the storage of player points, application credits and the like.

In various embodiments, the process controller 224 is operatively connected to the credit processing controller 226. In many embodiments, the credit processing controller 226 is operatively connected to one or more credit input devices 230 for generating incoming credit data from a credit input as described herein. The incoming credit data are communicated to the process controller 224. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller 226 is operatively connected to the one or more credit output devices 232 for generating a credit output based on outgoing credit data communicated from the process controller 224. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 226 is operatively connected to, and communicates with, a TITO system 234 or the like to determine incoming credit data representing amounts of credits to be transferred into the multiplayer variable skill objective interactive gaming system 220 and to determine outgoing credit data representing amounts of credits to be transferred out of the multiplayer variable skill objective interactive gaming system 220. In operation, the credit processing controller 226 communicates with one of the one or more connected credit input devices 230, such as a bill validator/ticket scanner, used to scan a credit input in the form of a TITO ticket having indicia of credit account data of a credit account of the TITO system 234. The credit processing controller 226 communicates the credit account data to the TITO system 234. The TITO system 234 uses the credit account data to determine an amount of credits to transfer to the credit processing controller 226 of the multiplayer variable skill objective interactive gaming system 220. The TITO system 234 communicates the amount of credits to the credit processing controller 226. The credit processing controller 226 communicates the amount of credits as incoming credit data to the process controller 224 which credits one or more credit meters with the amount of credits so that the credits can be used when a player makes wagers using the multiplayer variable skill objective interactive gaming system 220.

In many embodiments, the credit processing controller 226 includes a bill validator/ticket scanner as one of the one or more credit input devices 230. The credit processing controller 226 communicates with the bill validator/ticket scanner to scan currency used as a credit input to determine an amount of credits as incoming credit data to transfer credit to one or more credit meters associated with two or more players. The process controller 224 credits the one or more credit meters with the amount of credits so that the credits can be used when a player makes wagers using the multiplayer variable skill objective interactive gaming system 220.

In some embodiments, the credit processing controller 226 can use the TITO system 234 along with a ticket or voucher printer as one of the one or more credit output devices 232 to generate a TITO ticket as a credit output for a player. In operation, the credit processing controller 226 communicates, as outgoing credit data, data of an amount of credits to be credited to a credit account on the TITO system 234. The TITO system 234 receives the amount of credits and creates the credit account and credits the credit account with the amount of credits. The TITO system 234 generates credit account data for the credit account and communicates the credit account data to the credit processing controller 226. The credit processing controller 226 uses the ticket or voucher printer to print indicia of the credit account data onto a TITO ticket as a credit output.

In various embodiments, the credit processing controller 226 provides an interface to an electronic payment system 236 such an electronic wallet or the like. The electronic payment system 236 provides credit account data that is used for generating incoming credit data as a credit input and outgoing credit data as a credit output.

In some embodiments, the process controller 224 is operatively connected to a central determination controller (not shown). In operation, when a wagering sub-controller of the process controller 224 needs to determine a random outcome, the wagering sub-controller communicates a request to the central determination controller for the random outcome. The central determination controller receives the random outcome request and generates a random outcome in response to the random outcome request. The central determination controller communicates data of the random outcome to the process controller 224. The processing controller 224 receives the data of the random outcome and utilizes the random outcome as described herein. In some embodiments, the random outcome is drawn from a pool of pre-determined random outcomes.

In various embodiments, the wagering process controller 224 may be operatively connected to a progressive controller along (not shown) with one or more other process controllers of one or more other multiplayer variable skill objective interactive gaming systems. The progressive controller provides services for the collection and provision of credits used by the process controller 224 to provide random outcomes that have a progressive or pooling component.

FIG. 2C is a diagram of virtual reality gaming machine configuration of a multiplayer variable skill objective interactive gaming system in accordance with various embodiments of the invention. Types of a virtual reality gaming machine configuration of a multiplayer variable skill objective interactive gaming system include, but are not limited to, virtual reality gaming machines, virtual reality slot machines, virtual reality gaming devices, virtual reality arcade consoles and the like. A virtual reality gaming machine configuration of a multiplayer variable skill objective interactive gaming system includes an interactive controller, a process controller and a credit processing controller contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of a multiplayer variable skill objective interactive gaming system further includes a player area having virtual reality sensors for sensing player interactions and/or player movements within the player area, a player headset having a stereoscopic visual display for presentation of a stereoscopic presentation to a player, headphones for presenting a stereophonic sound presentation to a player, and one or more subwoofers for providing a hepatic or low frequency auditory presentation to the player.

The interactive controller communicates with the user input devices to detect player interactions with the virtual reality multiplayer variable skill objective interactive gaming system and commands and controls the user output devices to provide a user interface to two or more players of the virtual reality multiplayer variable skill objective interactive gaming system as described herein. The process controller communicates with the credit processing controller or player credit processing devices and to transfer credits into and out of the multiplayer variable skill objective interactive gaming system as described herein.

In many embodiments, the process controller is further connected to one or more side betting terminals that enable spectators of a player using the virtual reality multiplayer variable skill objective interactive gaming system to make side bets based on the performance of the player.

In many embodiments, the process controller is operatively connected to an external session sub-controller (not shown). The session sub-controller may provide session control for a wagering session or may provide services for management of a player account for the storage of player points, application credits and the like.

In various embodiments, the process controller is operatively connected to the credit processing controller. In many embodiments, the credit processing controller is operatively connected to one or more credit input devices for generating incoming credit data from a credit input as described herein. The incoming credit data are communicated to the process controller. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller is operatively connected to the one or more credit output devices for generating a credit output based on outgoing credit data communicated from the process controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller is operatively connected to, and communicates with, a TITO system or the like to determine incoming credit data representing amounts of credits to be transferred into the multiplayer variable skill objective interactive gaming system and to determine outgoing credit data representing amounts of credits to be transferred out of the multiplayer variable skill objective interactive gaming system. In operation, the credit processing controller communicates with one of the one or more connected credit input devices, such as a bill validator/ticket scanner, used to scan a credit input in the form of a TITO ticket having indicia of credit account data of a credit account of the TITO system. The credit processing controller communicates the credit account data to the TITO system. The TITO system uses the credit account data to determine an amount of credits to transfer to the credit processing controller of the multiplayer variable skill objective interactive gaming system. The TITO system communicates the amount of credits to the credit processing controller. The credit processing controller communicates the amount of credits as incoming credit data to the process controller which credits one or more credit meters with the amount of credits so that the credits can be used when a player makes wagers using the multiplayer variable skill objective interactive gaming system.

In many embodiments, the credit processing controller includes a bill validator/ticket scanner as one of the one or more credit input devices. The credit processing controller communicates with the bill validator/ticket scanner to scan currency used as a credit input to determine an amount of credits as incoming credit data to transfer credit to one or more credit meters associated with two or more players. The process controller credits the one or more credit meters with the amount of credits so that the credits can be used when a player makes wagers using the multiplayer variable skill objective interactive gaming system.

In some embodiments, the credit processing controller can use the TITO system along with a ticket or voucher printer as one of the one or more credit output devices to generate a TITO ticket as a credit output for a player. In operation, the credit processing controller communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller. The credit processing controller uses the ticket or voucher printer to print indicia of the credit account data onto a TITO ticket as a credit output.

In various embodiments, the credit processing controller provides an interface to an electronic payment system such an electronic wallet or the like. The electronic payment system provides credit account data that is used for generating incoming credit data as a credit input and outgoing credit data as a credit output.

In some embodiments, the process controller is operatively connected to a central determination controller (not shown). In operation, when a wagering sub-controller of the process controller needs to determine a random outcome, the wagering sub-controller communicates a request to the central determination controller for the random outcome. The central determination controller receives the random outcome request and generates a random outcome in response to the random outcome request. The central determination controller communicates data of the random outcome to the process controller. The processing controller receives the data of the random outcome and utilizes the random outcome as described herein. In some embodiments, the random outcome is drawn from a pool of pre-determined random outcomes.

In various embodiments, the wagering process controller may be operatively connected to a progressive controller along (not shown) with one or more other process controllers of one or more other multiplayer variable skill objective interactive gaming systems. The progressive controller provides services for the collection and provision of credits used by the process controller to provide random outcomes that have a progressive or pooling component.

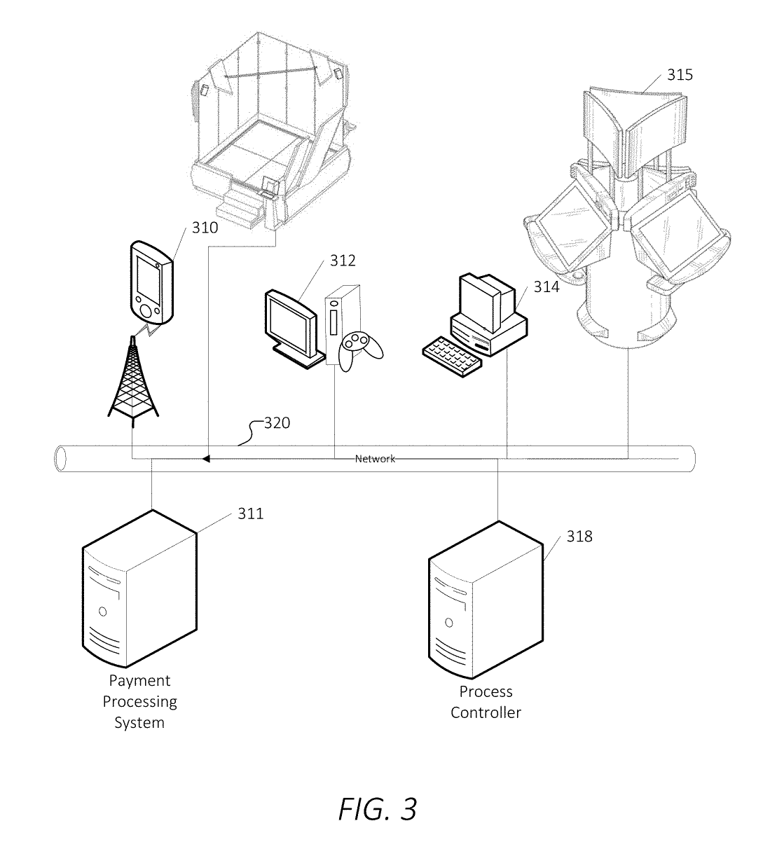

FIG. 3 is a diagram of distributed multiplayer variable skill objective interactive gaming systems in accordance with various embodiments of the invention. An interactive controller, such as interactive controller 102 of FIG. 1, may be constructed from or configured using one or more processing devices that perform the operations of the interactive controller. An interactive controller in a distributed multiplayer variable skill objective interactive gaming system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface, such as application control interface 122 of FIG. 1, and/or through the use of a multiplayer interactive application, such as multiplayer interactive application 110 of FIG. 1.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete multiplayer variable skill objective interactive gaming system and may be operatively connected using a communication link to a session and/or management controller.

Some multiplayer variable skill objective interactive gaming systems in accordance with many embodiments of the invention can be distributed across a plurality of devices in various configurations. One or more interactive controllers of a distributed multiplayer variable skill objective interactive gaming system, such as but not limited to, a mobile or wireless device 310, a gaming console 312, a personal computer 314, an electronic gaming machine 315, and a virtual reality gaming machine are operatively connected with a process controller 318 of a distributed multiplayer variable skill objective interactive gaming system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315 and a virtual reality gaming machine while one or more processes of a process controller as described herein can be executed by the process controller 318.

In many embodiments, a distributed multiplayer variable skill objective interactive gaming system and may be operatively connected using a communication link to a session controller (not shown), that performs the processes of a session controller as described herein.

In several embodiments, a distributed multiplayer variable skill objective interactive gaming system and may be operatively connected using a communication link to credit processing system 311, that performs the processes of one or more credit processing systems as described herein.

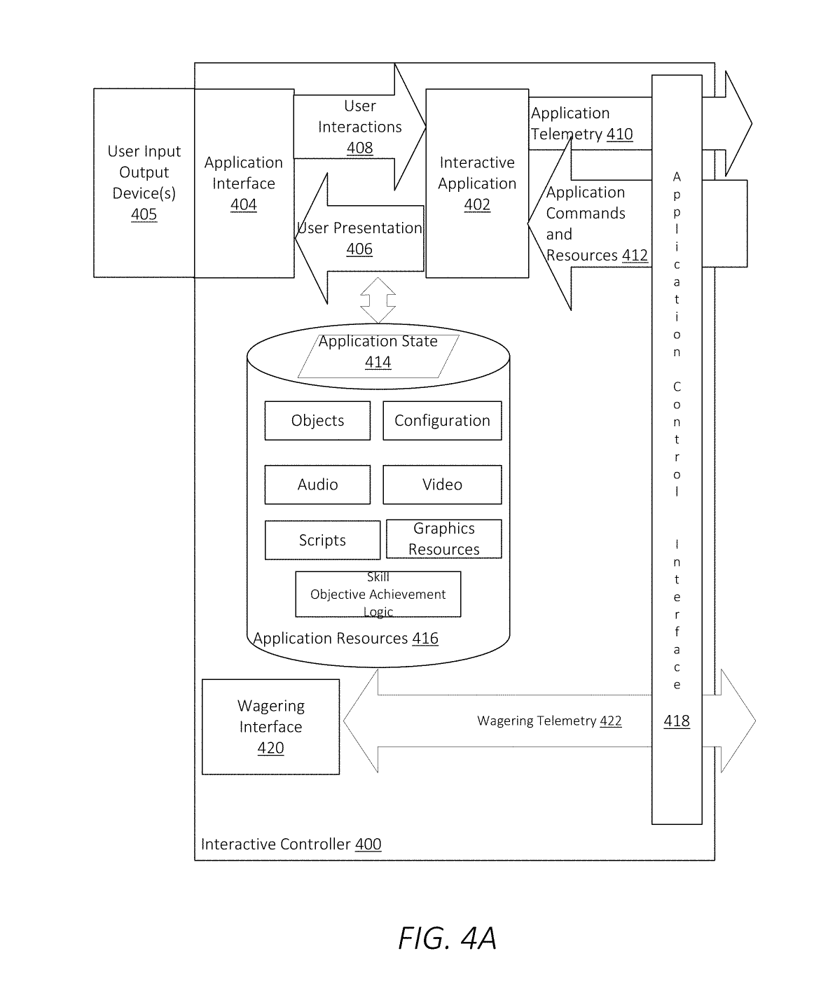

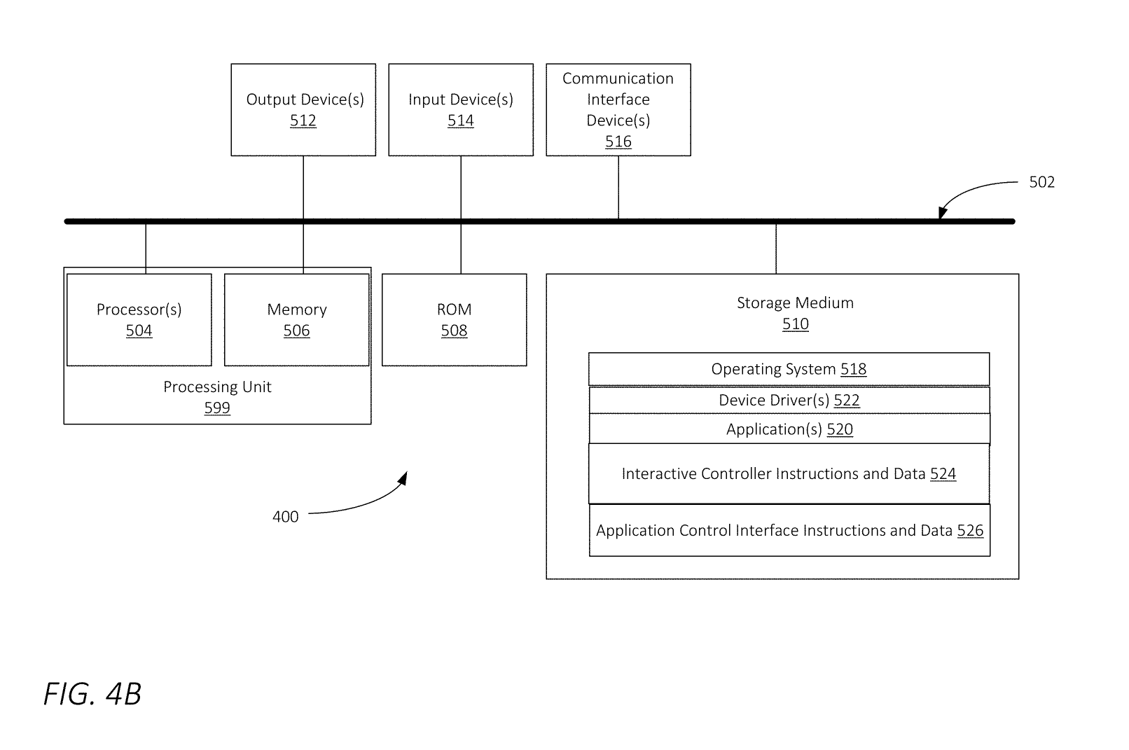

Referring now to FIG. 4A, an interactive controller 400, suitable for use as interactive controller 102 of FIG. 1, provides an execution environment for a multiplayer interactive application 402 of a multiplayer variable skill objective interactive gaming system. In several embodiments, an interactive controller 400 of a multiplayer variable skill objective interactive gaming system provides a multiplayer interactive application 402 that generates an application interface 404 for interaction with by a player. The multiplayer interactive application 402 generates a multiplayer presentation 406 that is presented to the player through the application interface 404 using one or more user input and output devices 405. The multiplayer presentation 406 may include audio features, visual features or tactile features, or any combination of these features. In various embodiments, the application interface 404 utilizes one or more user interface input and output devices 405 so that a player can interact with the multiplayer presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the multiplayer interactive application 402 in application telemetry data 410 that is communicated by interactive controller 400 to various other components of a multiplayer variable skill objective interactive gaming system as described herein. The multiplayer interactive application 402 receives application commands and resources 412 communicated from various other components of a multiplayer variable skill objective interactive gaming system as described herein. In some embodiments, the application telemetry data 410 may include player interactions with objects of the multiplayer interactive application and a skill objective achievement for a multiplayer wagering proposition presented to the player by the multiplayer interactive application 402.

In some embodiments, various components of the multiplayer interactive application 402 can read data from an application state 414 in order to provide one or more features of the multiplayer interactive application. In various embodiments, components of the multiplayer interactive application 402 can include, but are not limited to: a physics engine; a rules engine; an audio engine; a graphics engine and the like. The physics engine is used to simulate physical interactions between virtual objects in the multiplayer interactive application 402. The rules engine implements the rules of the multiplayer interactive application and a random number generator that may be used for influencing or determining certain variables and/or outcomes to provide a randomizing influence on the operations of the multiplayer interactive application. The graphics engine is used to generate a visual representation of the multiplayer interactive application state to the player. The audio engine is used to generate an audio representation of the multiplayer interactive application state to the player.

During operation, the multiplayer interactive application reads and writes application resources 416 stored on a data store of the interactive controller host. The application resources 416 may include objects having graphics and/or control logic used to provide application environment objects of the multiplayer interactive application. In various embodiments, the resources may also include, but are not limited to, video files that are used to generate a portion of the multiplayer presentation 406; audio files used to generate music, sound effects, etc. within the multiplayer interactive application; configuration files used to configure the features of the multiplayer interactive application; scripts or other types of control code used to provide various features of the multiplayer interactive application; graphics resources such as textures, objects, etc. that are used by a graphics engine to render objects displayed in a multiplayer interactive application; and skill objective achievement logic used along with player interactions to determine a skill objective achievement of a skill objective by one or more players.

In operation, components of the multiplayer interactive application 402 read portions of the application state 414 and generate the multiplayer presentation 406 for the player that is presented to the player using the user interface 404. The player perceives the multiplayer presentation and provides player interactions 408 using the user input devices. The corresponding player interactions are received as player actions or inputs by various components of the multiplayer interactive application 402. The multiplayer interactive application 402 translates the player actions into interactions with the virtual objects of the application environment stored in the application state 414. Components of the multiplayer interactive application use the player interactions with the virtual objects of the multiplayer interactive application and the multiplayer interactive application state 414 to update the application state 414 and update the multiplayer presentation 406 presented to the player. The process loops continuously while the player interacts with the multiplayer interactive application of the multiplayer variable skill objective interactive gaming system.

The interactive controller 400 provides one or more interfaces 418 between the interactive controller 400 and other components of a multiplayer variable skill objective interactive gaming system, such as, but not limited to, a process controller. The interactive controller 400 and the other multiplayer variable skill objective interactive gaming system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as determined by the multiplayer interactive application. The player interactions may also include resultant actions such as modifications to the application state 414 or game resources 416 resulting from the player's interactions taken in the multiplayer variable skill objective interactive gaming system multiplayer interactive application. In some embodiments, player interactions include, but are not limited to, actions taken by entities such as non-player characters (NPCs) of the multiplayer interactive application that act on behalf of or under the control of the player.

In various embodiments, the application commands and resources 412 include multiplayer wagering proposition application commands and/or resources used by the multiplayer interactive application to generate a presentation of a multiplayer wagering proposition presented to a player and to determine a skill objective achievement based on the player's skillful interaction with the presentation of the multiplayer wagering proposition.

In some embodiments, the interactive controller 400 includes a wagering user interface 420 used to provide multiplayer variable skill objective interactive gaming system telemetry data 422 to and from the player. The multiplayer variable skill objective interactive gaming system telemetry data 422 from the multiplayer variable skill objective interactive gaming system includes, but is not limited to, data used by the player to configure credit, application credit and interactive element wagers, and data about the chance-based proposition credits, application credits and interactive element wagers such as, but not limited to, credit, application credit and interactive element balances and credit, application credit and interactive element amounts wagered.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the multiplayer variable skill objective interactive gaming system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a player when the player interacts with the interactive controller; physiological sensors that monitor the physiology of the player; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in a multiplayer variable skill objective interactive gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to a multiplayer interactive application; and multiplayer variable skill objective interactive gaming system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a multiplayer variable skill objective interactive gaming system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of a multiplayer variable skill objective interactive gaming system includes a multiplayer interactive application server operatively connected to an interactive client using a communication link. The multiplayer interactive application server and multiplayer interactive application client cooperate to provide the features of an interactive controller as described herein.

In various embodiments, the interactive controller 400 may be used to construct other components of a multiplayer variable skill objective interactive gaming system as described herein.

In some embodiments, components of an interactive controller and a process controller of a multiplayer variable skill objective interactive gaming system may be constructed from or configured using a single device using processes that communicate using an interprocess communication protocol. In other such embodiments, the components of an interactive controller and a process controller of a multiplayer variable skill objective interactive gaming system may communicate by passing messages, parameters or the like.

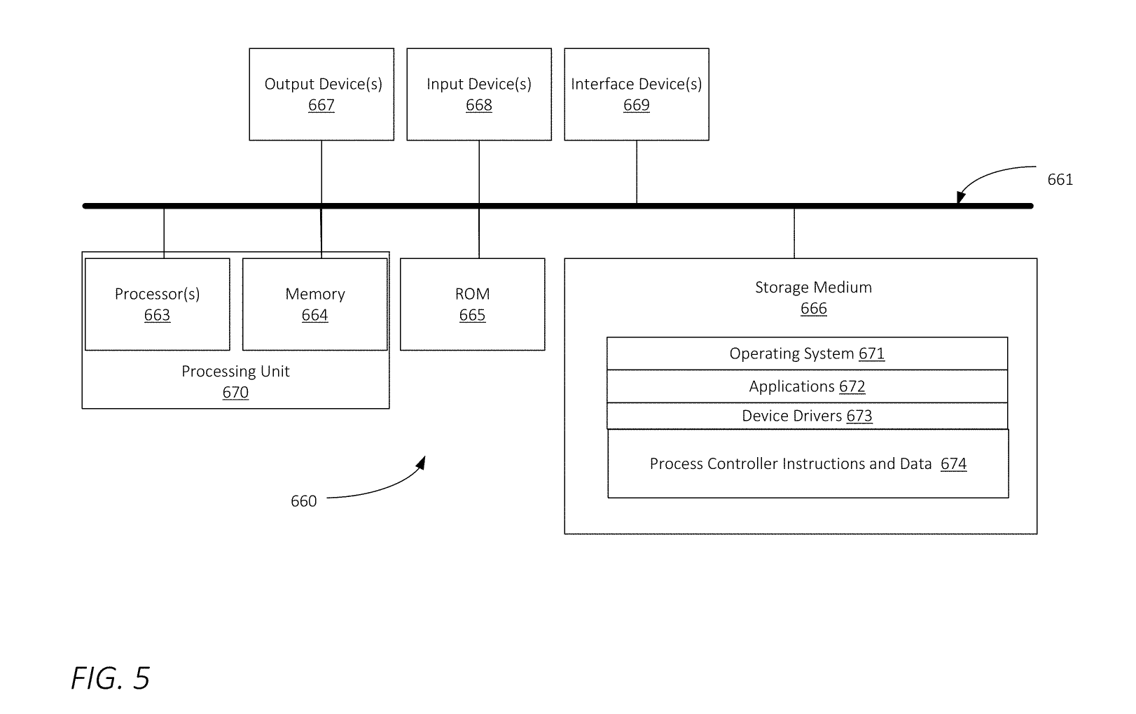

FIG. 5 is a diagram of a structure of a process controller, suitable for use as process controller 104 of FIG. 1, of a multiplayer variable skill objective interactive gaming system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for one or more processors 663, random access memory (RAM) 664, read only memory (ROM) 665, machine-readable storage medium 666, one or more user output devices 667, one or more user input devices 668, and one or more communication interface and/or network interface devices 669.

The one or more processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the one or more processors 663 are operatively connected to audio output devices such as, but not limited to: speakers; and/or sound amplifiers. In accordance with many of these embodiments, the one or more processors 663 are operatively connected to tactile output devices like vibrators, and/or manipulators.

In the example embodiment, the one or more processors 663 and the random access memory (RAM) 664 form a process controller processing unit 670. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a player when the player interacts with the process controller 660.

The one or more communication interface and/or network interface devices 669 provide one or more wired or wireless interfaces for exchanging data and commands between the process controller 660 and other devices that may be included in a multiplayer variable skill objective interactive gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; one or more applications 672; one or more device drivers 673; and multiplayer variable skill objective interactive gaming system process controller instructions and data 674 for use by the one or more processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the one or more processors 663 via the bus 661, and then executed by the one or more processors 663. Data used by the one or more processors 663 are also stored in memory 664, and the one or more processors 663 access such data during execution of the machine-executable instructions. Execution of the machine-executable instructions causes the one or more processors 663 to control the process controller 660 to provide the features of a multiplayer variable skill objective interactive gaming system process controller as described herein.

Although the process controller 660 is described herein as being constructed from or configured using one or more processors and instructions stored and executed by hardware components, the process controller can be composed of only hardware components in accordance with other embodiments. In addition, although the storage medium 666 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the user input devices or user output devices may be operatively connected to the one or more processors 663 via one of the interfaces or using a communication link.

In various embodiments, the process controller 660 may be used to construct other components of a multiplayer variable skill objective interactive gaming system as described herein.

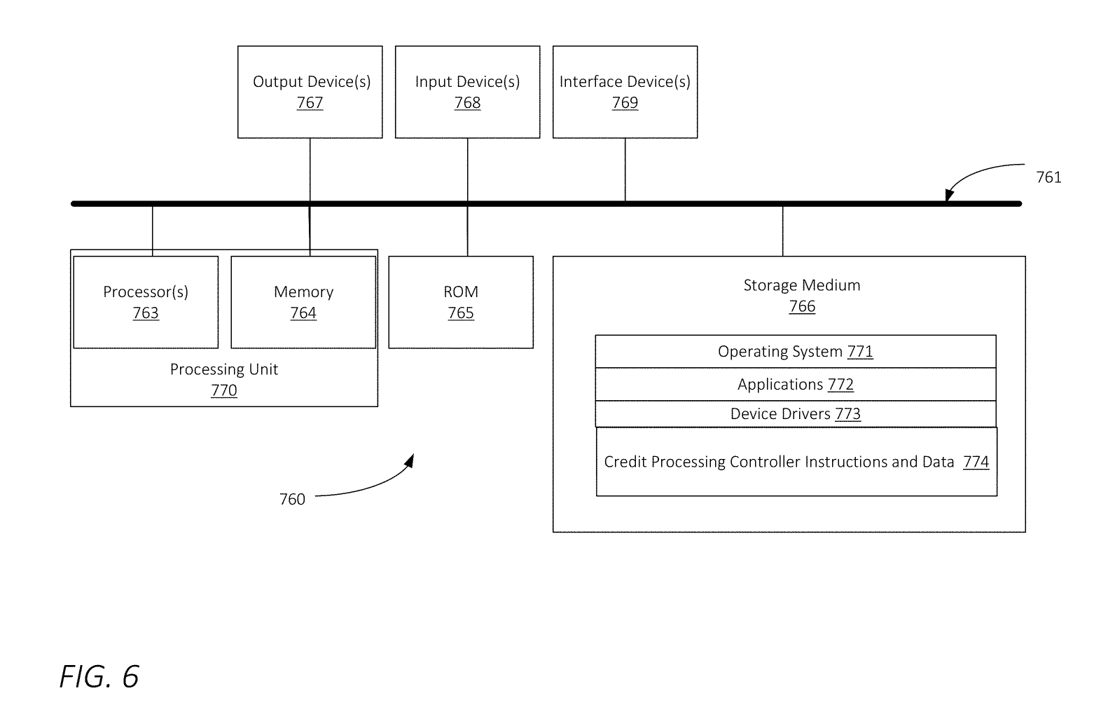

FIG. 6 is a diagram of a structure of a credit processing controller, suitable for use as credit processing controller 105 of FIG. 1, of a multiplayer variable skill objective interactive gaming system in accordance with various embodiments of the invention. A credit processing controller may be constructed from or configured using one or more processing devices that perform the operations of the credit processing controller. In many embodiments, a credit processing controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing controller 760 includes a bus 761 providing an interface for one or more processors 763, random access memory (RAM) 764, read only memory (ROM) 765, machine-readable storage medium 766, one or more user output devices 767, one or more user input devices 768, and one or more communication interface and/or network interface devices 769.

The one or more processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the one or more processors 763 are operatively connected to audio output devices such as, but not limited to: speakers; and/or sound amplifiers. In accordance with many of these embodiments, the one or more processors 763 are operatively connected to tactile output devices like vibrators, and/or manipulators.

In the example embodiment, the one or more processors 763 and the random access memory (RAM) 764 form a credit processing controller processing unit 770. In some embodiments, the credit processing controller processing unit includes one or more processors operatively connected to one or more of a RAM, ROM, and machine-readable storage medium; the one or more processors of the credit processing controller processing unit receive instructions stored by the one or more of a RAM, ROM, and machine-readable storage medium via a bus; and the one or more processors execute the received instructions. In some embodiments, the credit processing controller processing unit is an ASIC (Application-Specific Integrated Circuit). In some embodiments, the credit processing controller processing unit is a SoC (System-on-Chip).

Examples of user input devices 768 include, but are not limited to: tactile devices including but not limited to, keyboards, keypads, foot pads, touch screens, and/or trackballs; non-contact devices such as audio input devices; motion sensors and motion capture devices that the credit processing controller can use to receive inputs from a player when the player interacts with the credit processing controller 760.

The one or more communication interface and/or network interface devices 769 provide one or more wired or wireless interfaces for exchanging data and commands between the credit processing controller 760 and other devices that may be included in a multiplayer variable skill objective interactive gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the credit processing controller 760 such as, but not limited to: an operating system 771; one or more applications 772; one or more device drivers 773; and credit processing controller instructions and data 774 for use by the one or more processors 763 to provide the features of a credit processing controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the one or more processors 763 via the bus 761, and then executed by the one or more processors 763. Data used by the one or more processors 763 are also stored in memory 764, and the one or more processors 763 access such data during execution of the machine-executable instructions. Execution of the machine-executable instructions causes the one or more processors 763 to control the credit processing controller 760 to provide the features of a multiplayer variable skill objective interactive gaming system credit processing controller as described herein.

Although the credit processing controller 760 is described herein as being constructed from or configured using one or more processors and instructions stored and executed by hardware components, the credit processing controller can be composed of only hardware components in accordance with other embodiments. In addition, although the storage medium 766 is described as being operatively connected to the one or more processors through a bus, those skilled in the art of credit processing controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the user input devices or user output devices may be operatively connected to the one or more processors 763 via one of the interfaces or using a communication link.

In various embodiments, the credit processing controller 760 may be used to construct other components of a multiplayer variable skill objective interactive gaming system as described herein.

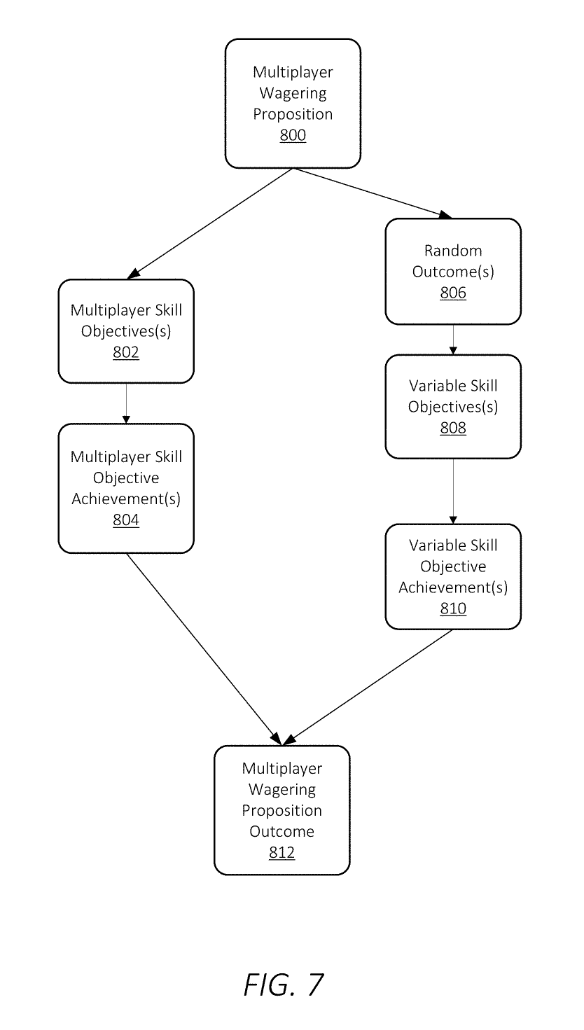

FIG. 7 is a block diagram of a wagering process of a multiplayer variable skill objective interactive gaming system during a wagering session in accordance with various embodiments of the invention. A multiplayer variable skill objective interactive gaming system provides at least one multiplayer wagering proposition 800 to two or more players within the context of a multiplayer interactive application. The wagering proposition includes one or more multiplayer skill objectives 802 that the two or more players attempt to achieve. In addition, the multiplayer wagering proposition includes one or more variable skill objectives 808 that are provided to at least one player of the two or more players and the at least one player attempts to achieve the variable skill objective. The variable skill objectives are determined at least on a partial basis of one or more random outcomes 806. A multiplayer wagering proposition outcome 812 depends on multiplayer skill objective achievements 804 of the two or more players and on variable skill objective achievements 810 by the at least one player provided with the variable skill objectives.

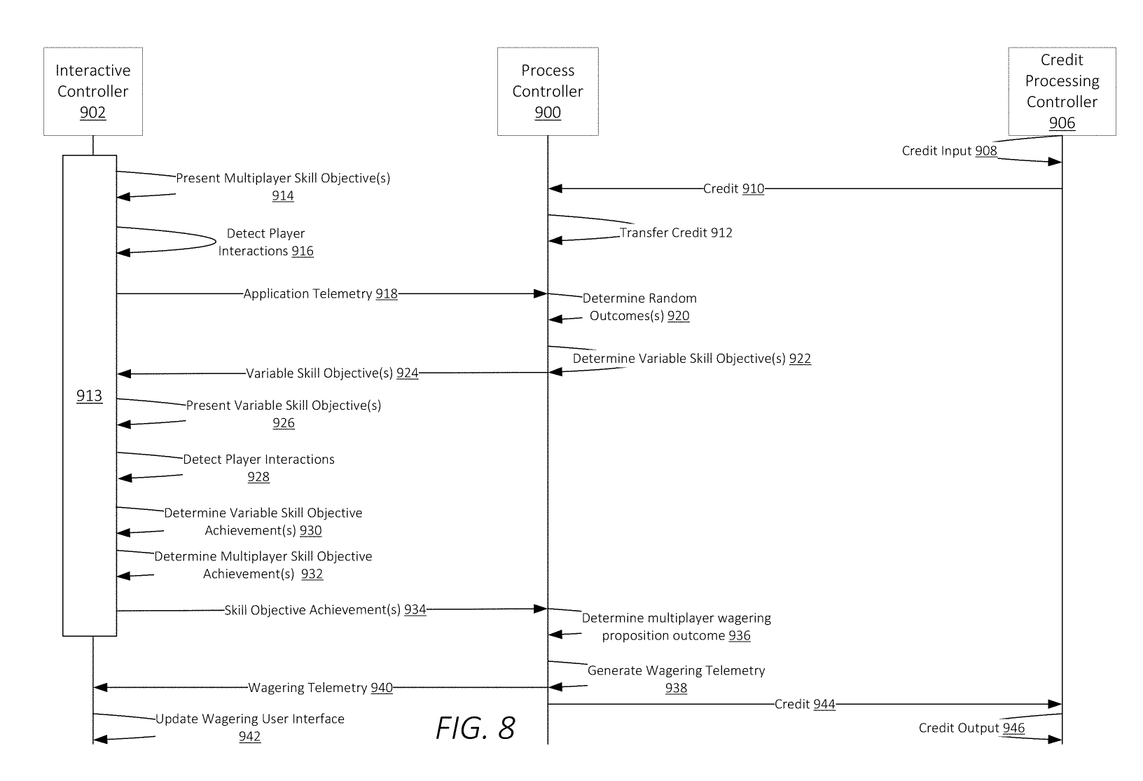

FIG. 8 is a sequence diagram of interactions between components of a multiplayer variable skill objective interactive gaming system during a wagering session in accordance with various embodiments of the invention.

In many embodiments, the wagering session is within a context of a multiplayer interactive application wherein two or more players compete or cooperate to achieve one or more multiplayer skill objectives. The wagering session includes one or more wagering propositions associated with the two or more players' achievement of the one or more multiplayer skill objectives.

The components of the multiplayer variable skill objective interactive gaming system include a process controller 900, such as process controller 104 of FIG. 1, an interactive controller 902, such as interactive controller 102 of FIG. 1, and a credit processing controller 904, such as credit processing controller 105 of FIG. 1.

In some embodiments, at a beginning of the wagering session, the process includes a credit input 908 to the multiplayer variable skill objective interactive gaming system with process controller 900 communicating with the credit processing controller 906 to receive incoming credit data 910. The process controller 900 uses the incoming credit data to transfer 912 credits onto two or more player credit meters associated with two or more players of the multiplayer variable skill objective interactive gaming system, thus transferring credits into the multiplayer variable skill objective interactive gaming system and on to the two or more player credit meters.

During a multiplayer wagering session 913, the interactive controller 902 presents 914 a multiplayer interactive application having one or more multiplayer skill objectives of a multiplayer wagering proposition to the two or more players using one or more user output devices as described herein. The presentation of the multiplayer wagering proposition is presented to the two or more players in a user interface of the multiplayer interactive application of the interactive controller 902. The interactive controller 902 detects 916 player interactions of the two or more players with one or more user input devices of the interactive controller in accordance with the user interface of the multiplayer interactive application provided by the interactive controller 902.

The interactive controller 902 communicates application telemetry data 918 to the process controller 900. The application telemetry data 918 includes, but is not limited to, the player interactions detected by the interactive controller 902.

The process controller 900 receives the application telemetry data 918. The process controller 900 uses the application telemetry data to determine if one or more variable skill objectives are to be generated. Upon determination by the process controller 900 that the player interactions indicate that one or more variable skill objectives are to be generate in accordance with the multiplayer wagering proposition, the process controller 900 determines 920 one or more random outcomes and uses the one or more random outcomes to determine 922 one or more variable skill objectives as described herein to be provided to at least one player of the two or more players engaged in the multiplayer wagering proposition. The process controller 900 communicates data of the one or more variable skill objectives 924 to the interactive controller 902.

In some embodiments, a variable skill objective includes a skill disruptor provided to at least one player of the two or more players that makes it more difficult for the at least one player to continue playing a multiplayer skill-based game implemented by a multiplayer interactive application of the multiplayer variable skill objective interactive gaming system.

In some embodiments, a variable skill objective includes a skill enhancer provided to at least one player of the two or more players that makes it easier for the at least one player to continue playing a multiplayer skill-based game implemented by a multiplayer interactive application of the multiplayer variable skill objective interactive gaming system.

In some embodiments, a variable skill objective includes a game resource provided to at least one player of the two or more players that is a necessary game resource for the at least one player to continue playing a multiplayer skill-based game implemented by a multiplayer interactive application of the multiplayer variable skill objective interactive gaming system.

The interactive controller 902 receives the variable skill objective data 924 from the process controller 900 and uses the variable skill objective data 924 to present 926 to the at least one player the one or more variable skill objectives within a context of the multiplayer wagering proposition as described herein. The interactive controller 902 detects 928 further player interactions of the two or more players with the presentation of the multiplayer wagering proposition. The interactive controller 902 uses the further player interactions to determine 930 a variable skill objective achievement by the at least one player. The interactive controller 902 also uses the further player interactions to determine a multiplayer skill objective achievement by the two or more players. The interactive controller also uses the player interactions to determine a variable skill objective achievement by the at least one player. The interactive controller communicates data of the skill objective achievements 934 to the process controller 900. The process controller receives the data of the skill objective achievements 934 and uses the data of the skill objective achievements to determine 936. a multiplayer wagering proposition outcome. The process controller updates the two or more player credit meters associated with the two or more players using the multiplayer wagering proposition outcome data.

The process controller 900 generates 938 wagering telemetry data 940 using the multiplayer wagering proposition outcome data 940 and data of the updated two or more credit meters. The process controller 900 communicates the wagering telemetry data 940 to the interactive controller 902. The interactive controller 902 receives the wagering telemetry data 940. The interactive controller 902 updates 942 a wagering user interface on a partial basis of the wagering telemetry data 940.

In many embodiments, upon determining that the wagering session is completed, such as by receiving a cashout communication from the two or more players of the multiplayer variable skill objective interactive gaming system, the process controller 900 transfers credits off of the two or more player credit meters, generates outgoing credit data 944 on the basis of the credits transferred off of the two or more player credit meters, and communicates the outgoing credit data 944 to the credit processing controller 906. The credit processing controller receives the outgoing credit data 944 and generates 946 a credit output as described herein, thus transferring credits off of the two or more player credit meters and out of the multiplayer variable skill objective interactive gaming system.

In some embodiments, at a beginning of the wagering session, the process includes an application credit input to the multiplayer variable skill objective interactive gaming system with the process controller 900 communicating with the credit processing controller 906 to receive incoming application credit data. The process controller 900 uses the incoming application credit data to transfer application credits onto two or more application credit meters associated with two or more players of the multiplayer variable skill objective interactive gaming system, thus transferring application credits into the multiplayer variable skill objective interactive gaming system and on to the two or more application credit meters. The process controller 900 uses the skill objective achievement data 934 to determine an amount of application credit to award to a player based on the player's skillful interactions with a multiplayer interactive application executed by the interactive controller 902. Upon determining that the wagering session is completed, such as by receiving a cashout communication from two or more players of the multiplayer variable skill objective interactive gaming system, the process controller 900 transfers application credits off of the two or more application credit meters, generates outgoing application credit data on the basis of the application credits transferred off of the one or more application credit meters, and communicates the outgoing application credit data to the credit processing controller 906. The credit processing controller receives the outgoing application credit data and generates an application credit output as described herein, thus transferring application credits off of the one or more application credit meters and out of the multiplayer variable skill objective interactive gaming system.

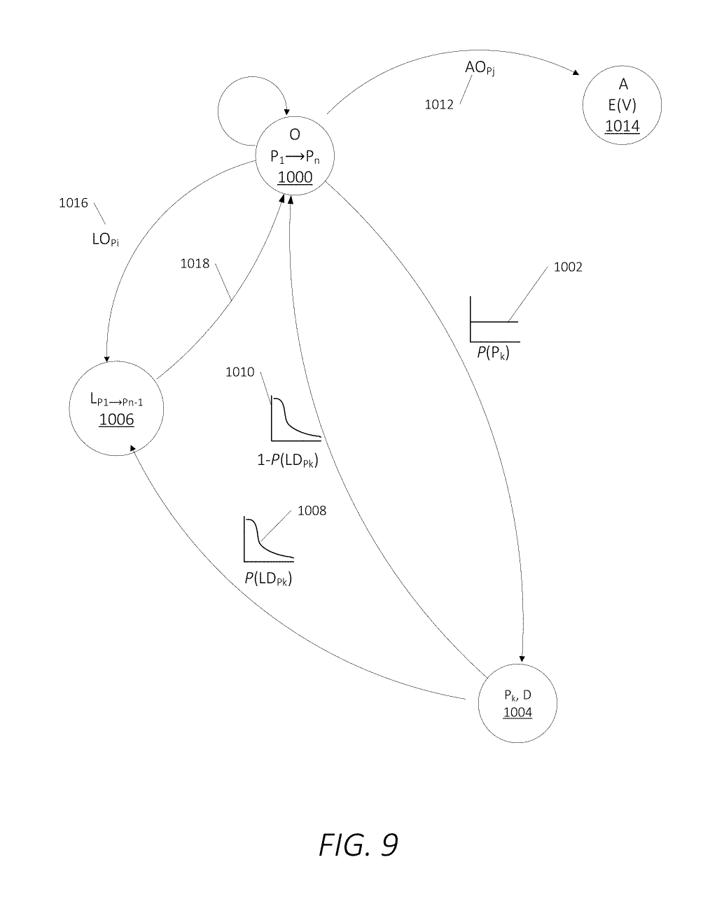

FIG. 9 is a state diagram illustrating a wagering process of a multiplayer variable skill objective interactive gaming system in accordance with various embodiments of the invention. In such a wagering process, a multiplayer interactive application of the multiplayer variable skill objective interactive gaming system implements a multiplayer wagering proposition having a multiplayer skill objective as described herein. During the wagering process, two or more players attempt to achieve the multiplayer skill objective. While the two or more players attempt to achieve the multiplayer skill objective, a variable skill objective in the form of a skill disruptor is randomly generated during the wagering process such that the skill disruptor lowers the probability that at least one of the players will be able to achieve the multiplayer skill objective of the multiplayer wagering proposition.

In the wagering process, the multiplayer wagering proposition includes a multiplayer skill objective, as indicated by state O 1000, that each player of the two or more players, as indicated by P₁->Pₙ, attempts to achieve. As the two or more players attempt to achieve the multiplayer skill objective, at least one player of the two or more players, indicated as Pₖ, is determined at random, as indicated by probability P(Pₖ) 1002, to receive a variable skill objective in the form of a skill disruptor as described herein. The wagering process then transitions to state Pₖ, D 1004 in which the at least one player attempts to achieve the variable skill objective of overcoming skill disruptor through skillful play.

The at least one player, Pₖ, may fail to overcome the skill disruptor, that is the at least one player may not be able to achieve the variable skill objective of overcoming the skill disruptor, leading to a loss by the at least one player, Pk, and the multiplayer variable skill objective interactive gaming system transitions to state L_{P1->Pn-1} 1006. The probability of the at least one player failing to overcome the skill disruptor, and thus the probability of the wagering process transitioning from state Pk, D, 1004 to state L_{P1->Pn-1} 1006, is P(LD_{Pk}) 1008.

If the at least one player is able to overcome the skill disruptor, the multiplayer variable skill objective interactive gaming system transitions to state O 1000 where the at least one player Pₖ continues to attempt to achieve the multiplayer skill objective along with any remaining players of the two or more players. The probability that the at least one player is able to overcome the skill disruptor is the complement of the probability of not overcoming the skill disruptor, namely 1−P(LD_{Pk}) 1010.

While the wagering process is in state O 1000, each remaining player of the two or more players attempts to achieve the multiplayer skill objective. If a player, Pᵢ, of the two or more players lacks the skill needed to achieve the multiplayer skill objective, the multiplayer variable skill objective interactive gaming system transitions, as indicated by LO_{Pi} 1016, to state L_{P1->Pn-1} 1006 and player Pᵢ is no longer able to continue to attempt to achieve the multiplayer skill objective. The multiplayer variable skill objective interactive gaming system transitions 1018 from sate L_{P1->Pn-1} 1006 to sate O 1000 where any remaining players of the two or more players continue to attempt to achieve the multiplayer skill objective.

If a player, Pᵢ, of the two or more players is able to achieve the multiplayer skill objective, the multiplayer variable skill objective interactive gaming system transitions, as indicated by AO_{Pj}, 1012, to state A 1014 where player Pⱼ is awarded a specified award E(V).

In some embodiments, a probability, P(LO_{Pi}), that a player, Pᵢ, of the two or more players will fail to achieve the multiplayer skill objective because of player Pᵢ's poor skillful play may be determined by comparison of player Pᵢ's skillful play to the skillful play of the other players of the two or more players using a skill metric collected as the two or more players attempt to achieve the multiplayer skill objective. In addition, a probability, P(AO_{Pj}), that a player, Pj, will achieve the multiplayer skill objective because of player Pⱼ's skillful play may be determined by comparison of player Pᵢ's skillful play to the skillful play of the other players of the two or more players using a skill metric collected as the two or more players attempt to achieve the multiplayer skill objective. In such a case, the probability that player Pⱼ will be able to achieve the multiplayer skill objective of state O 1000 in the absence of a skill disruptor is 1/n where n is the number players attempting to achieve the multiplayer skill objective. Accordingly, the probability that player Pᵢ fails to achieve the multiplayer skill objective is the complement of the probability of player Pⱼ achieving the multiplayer skill objective, that is 1−1/n or (n−1)/n.

In various embodiments, a probability that a player will lose because of the player's inability to overcome the skill disruptor, P(LD_{Pk}) 1008, can be determined from historical player skill metrics collected while attempting to overcome the skill disruptor. The probability that any player will be able to skillfully overcome the skill disruptor, and thus cause a transition from state Pk, D 1004, back to state O 1000, is then 1−P(LD_{Pk}) 1010.

It can be seen by inspection that if the probability, P(LO_{Pk}), is high that a specific player, Pₖ, will be able to achieve the multiplayer skill objective of the multiplayer wagering proposition through skillful play, the probability, P(AO_{Pk}) that player Pₖ will be able to achieve the multiplayer skill objective, and thus be awarded the specified award, is dependent upon the probability, P(Pₖ), that player Pₖ is determined to be the player to whom the skill disruptor is provided and the probability, P(LD_{Pk}), that player Pₖ will not be able to overcome the skill disruptor. Furthermore, if P(LD_{Pk}) is unity, that is there is no way for player Pₖ to overcome the skill disruptor once the skill disruptor is generated, the probability that player Pₖ will be able to achieve the multiplayer skill objective is mostly dependent upon the probability that player Pₖ is determined to receive the skill disruptor. That is, as P(LO_{Pk})⇒0 and P(LD_{Pk})⇒1, then P(AO_{Pk})⇒0, that is for a skillful player, the probability of achieving the multiplayer skill objective without the introduction of the skill disruptor is high and the probability not achieving the multiplayer skill objective with the introduction of the skill disruptor is low.

During operation, a multiplayer variable skill objective interactive gaming system implements a stateful process or protocol in order to implement a multiplayer wagering proposition having a skill disruptor. In an example embodiment, the multiplayer variable skill objective interactive gaming system executes a multiplayer interactive application that presents a multiplayer skill-based game to two or more players and enters a multiplayer skill objective state O 1000 where the two or more players attempt to achieve a multiplayer skill objective of the multiplayer skill-based game. While in the multiplayer skill objective state O 1000, the multiplayer variable skill objective interactive gaming system determines at least one player of the two more players too which a skill objective in the form of a skill disruptor will be provided on the basis of a random outcome. The skill disruptor is generated within the multiplayer skill-based game based on a random outcome during the players' skillful play of the multiplayer skill-based game. The multiplayer variable skill objective interactive gaming system transitions, as indicated by probability P(Pk) 1002, from the multiplayer skill objective state O 1000 to a skill disruptor state Pk, D, 1104. While in the skill disruptor state Pk, D 1004, the multiplayer variable skill objective interactive gaming system determines if the at least one player has overcome the skill disruptor through skillful play of the multiplayer skill-based game. In other words, the multiplayer variable skill objective interactive gaming system determines if the at least one player has been able to achieve a skill objective of overcoming the skill disruptor through skillful play of the multiplayer.

When multiplayer variable skill objective interactive gaming system determines that the at least one player has not been able to overcome the skill disruptor, the multiplayer variable skill objective interactive gaming system transitions to a loss state Pk, L 1006 as indicated by probability P(LD_{Pk}) 1008.

When the multiplayer variable skill objective interactive gaming system determines that the player has been able to overcome the skill disruptor, that is achieve the skill objective represented by the skill disrupter, the multiplayer variable skill objective interactive gaming system transitions to multiplayer skill objective state O 1000 as indicated by probability 1−P(LD_{Pk}) 1010.

In the multiplayer skill objective state O 1000, the multiplayer variable skill objective interactive gaming system determines if the at least one player is unable to achieve a multiplayer skill objective. If the multiplayer variable skill objective interactive gaming system determines that the at least one player has not been able to achieve the multiplayer skill objective, the multiplayer variable skill objective interactive gaming system transitions to the loss state Pk, L 1006 as indicated by probability P(LO_{Pk}) 1012. If the multiplayer variable skill objective interactive gaming system determines that the player has been able to achieve the multiplayer skill objective, then the multiplayer variable skill objective interactive gaming system transitions to achievement state Pk, A, as indicated by probability P(A_{Pk}) 1014.

In many embodiments, the multiplayer skill objective is associated with a skill-based multiplayer game. The two or more players attempt to achieve the multiplayer skill objective by skillfully playing the multiplayer skill-based game associated with the multiplayer skill objective to determine one or more winning players of the multiplayer skill-based game.

In some embodiments, the multiplayer wagering proposition is a cooperative multiplayer wagering proposition where two or more players cooperate to achieve a cooperative multiplayer skill objective.

In various embodiments, the multiplayer wagering proposition is a competitive multiplayer wagering proposition where two or more players compete against one another to achieve a competitive multiplayer skill objective. In some such embodiments, the multiplayer skill objective is for each player to defeat all other players in head-to-head competition. In other such embodiments, the multiplayer skill objective for each player is independent of the other players' multiplayer skill objectives.

In various embodiments, the at least one player is determined and the skill disruptor is generated by the multiplayer interactive application in accordance with a random outcome generated by a random number generator where the random outcome has a known distribution.

In some embodiments, another random outcome is used to determine which of a plurality of skill disruptors are generated. In some such embodiments, a random outcome is used to generate an index into a lookup table of possible skill disruptors.

In some embodiments, a known distribution of the random outcome is a uniform distribution. In other embodiments, the known distribution of the random outcome is a normal distribution.

In various embodiments, a lookup table is used to map the random outcome to the introduction of the skill disruptor into the multiplayer skill-based game.

In many embodiments, the probability distribution of the probability of the player achieving a multiplayer skill objective can be described using a cumulative distribution.

In some embodiments, the probability distribution of the probability of the player overcoming a skill disruptor can be described using a cumulative distribution.

In many embodiments, the stateful process or protocol includes determining by the multiplayer variable skill objective interactive gaming system a commitment of an amount of credit to a wager at the multiplayer skill objective state O 1000, and determining by the multiplayer variable skill objective interactive gaming system a specified award of an amount of credit, E(V), for the wager while in the skill objective achievement state Pk, A 1014. In various embodiments, the value of the specified award is determined by the multiplayer variable skill objective interactive gaming system using a random outcome and a paytable.

In some embodiments, a specified award is specified based on a gaming parameter for one or more multiplayer skill objectives during a wagering session as a specified award for the one or more multiplayer skill objectives. In example embodiments, gaming parameters may include, but are not limited to, an amount of credits committed in a wager, an identity of a player, an amount of time that the player has been playing a multiplayer skill-based game, an amount of credits wagered over time, a location of an electronic gaming machine, etc.

In some embodiments, an amount of credits is fixed for one or more multiplayer skill objectives as a specified award for the one or more multiplayer skill objectives.

In some embodiments, an amount of credits for a specified award of a player achieving a multiplayer skill objective is specified based on a random outcome.

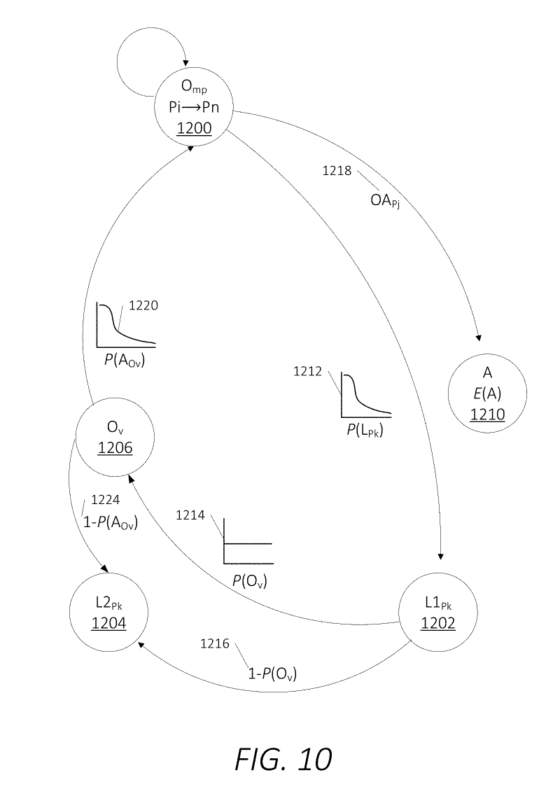

FIG. 10 is a state diagram illustrating another wagering process of a multiplayer variable skill objective interactive gaming system in accordance with various embodiments of the invention. In this wagering process, two or more players attempt to achieve a multiplayer skill objective through skillful play. During skillful play by the two or more players, a skill enhancer is randomly generated by the multiplayer variable skill objective interactive gaming system such that the skill enhancer raises the probability that at least one of the players will be able to achieve the multiplayer skill objective and be awarded a specified award.

In the wagering process, the multiplayer variable skill objective interactive gaming system provides a multiplayer skill objective, as indicated by multiplayer skill objective state O 1200, that two or more players attempt to achieve, as indicated by P1->Pn, of state O 1200. As the players attempt to achieve the multiplayer skill objective, at least one player, Pk, will fail to achieve the multiplayer skill objective and experience an intermediate loss and the wagering process will transition to initial loss state L1_{Pk} 1202.

While in initial loss state L1_{Pk} 1202, the multiplayer variable skill objective interactive gaming system randomly generates a variable skill objective in the form of skill enhancer specified for the at least one player, causing the wagering process to transition to a variable skill objective state Oᵥ 1206. While the multiplayer variable skill objective interactive gaming system is in the variable skill objective state, the at least one player attempts to utilize the skill enhancer. If the player is successful at utilizing the skill enhancer, that is the player is able to achieve the variable skill objective, the multiplayer variable skill objective interactive gaming system transitions to the multiplayer skill objective state O 1200 where the at least one player continues to attempt to achieve the multiplayer skill objective.

If the variable skill objective is not generated by the multiplayer variable skill objective interactive gaming system, then the multiplayer variable skill objective interactive gaming system transitions to a final loss state L2_{Pk} 1204, and the at least one player, Pₖ, will experience a final loss.

If a player, Pj, of the two or more players is able to achieve the multiplayer skill objective, the multiplayer variable skill objective interactive gaming system transitions, as indicated by OA_{Pj} 1218, to an award state A 1210, in which a specified award, E(A), is awarded to the successful player.

In various embodiments, the probability that the at least one player, Pₖ will experience an intermediate loss because of the at least one player's poor skillful play during the at least one player's attempt to achieve the multiplayer skill objective, herein termed P(L_{Pk}) 1212, causing the wagering process to transition from multiplayer skill objective state O 1200 to initial loss state L1_{Pk} 1202 can be determined from historical player skill metrics collected during players' skillful play of a multiplayer skill-based game associated with the multiplayer skill objective.

In many embodiments, the variable skill objective in the form of a skill enhancer is generated by the multiplayer variable skill objective interactive gaming system in accordance with a random outcome having a known distribution and generated by a random number generator of a process controller, causing the multiplayer variable skill objective interactive gaming system to transition to the variable skill objective state Oᵥ 1206. The probability of such a transition occurring in the wagering process from the initial loss state L1 1202 to the variable skill objective state Oᵥ 1206 is P(Oᵥ) 1214.

Similarly, the probability that the variable skill objective will not be generated by the multiplayer variable skill objective interactive gaming system causing the player to experience a final loss after the intermediate loss and the multiplayer variable skill objective interactive gaming system wagering process transitioning from state L1_{Pk} 1202 to final loss state L2_{Pk} 1204 is the complement of P(Oᵥ), namely 1−P(Oᵥ) 1216.

The probability that the at least one player will be able to successfully utilize the skill enhancer, that is achieve the variable skill objective as embodied in the skill enhancer, is P(A_{Ov}) 1220.

The probability that the at least one player will not be able to successfully utilize the skill enhancer, that is they are unable to achieve the variable skill objective as embodied in the skill enhancer, is the complement of P(A_{Ov}), namely 1−P(A_{Ov}) 1224.

The probability that the at least one player will be able to achieve the multiplayer skill objective, thus causing the wagering process to transition from multiplayer skill objective state O 1200 to multiplayer skill objective achievement state A 1210, is P(OA_{Pk}).

In various embodiments, it can be seen by inspection that if a player has a high probability of experiencing an intermediate loss while attempting to achieve the multiplayer skill objective, the probability that the player will be able to achieve the multiplayer skill objective, and thus be awarded the specified award, is dependent upon the probability that the variable skill objective will be generated by the multiplayer variable skill objective interactive gaming system and that the player will be able to use the skill enhancer of the variable skill objective to achieve the variable skill objective and return to attempting to achieve multiplayer skill objective. That is, as P(L_{Pk})⇒1, then P(OA_{Pk})⇒P(Oᵥ)×P(A_{Ov}), that is a player's probability of being able to achieve the multiplayer skill objective can be determined almost exclusively by the probability of the variable skill objective in the form of a skill enhancer being generated if the probability of experiencing an intermediate loss is high.

In some embodiments, a variable skill objective in a form of a skill enhancer is provided to a player on the basis of a random outcome, that is, a player, P_{K}, of two or more players is selected at random to receive a skill enhancer.

In many embodiments, the multiplayer skill objective is associated with a skill-based multiplayer game. The two or more players attempt to achieve the multiplayer skill objective by skillfully playing the multiplayer skill-based game associated with the multiplayer skill objective to determine one or more winning players of the multiplayer skill-based game.

In some embodiments, the multiplayer wagering proposition is a cooperative multiplayer wagering proposition where two or more players cooperate to achieve a cooperative multiplayer skill objective.

In various embodiments, the multiplayer wagering proposition is a competitive multiplayer wagering proposition where two or more players compete against one another to achieve a competitive multiplayer skill objective. In some such embodiments, the multiplayer skill objective is for each player to defeat all other players in head-to-head competition. In other such embodiments, the multiplayer skill objective for each player is independent of the other players' multiplayer skill objectives.

In various embodiments, the at least one player is determined and the variable skill objective in the form of a skill enhancer is generated by the multiplayer interactive application in accordance with a random outcome generated by a random number generator where the random outcome has a specified distribution.

In some embodiments, another random outcome is used to determine which of a plurality of skill enhancers are generated. In some such embodiments, a random outcome is used to generate an index into a lookup table of possible skill enhancers.

In some embodiments, a specified distribution of the random outcome is a uniform distribution. In other embodiments, the specified distribution of the random outcome is a normal distribution.

In many embodiments, the probability distribution of the probability of the player achieving a multiplayer skill objective can be described using a cumulative distribution.

In some embodiments, the probability distribution of the probability of the player successfully utilizing the skill enhancer can be described using a cumulative distribution.

During operation, a multiplayer variable skill objective interactive gaming system implements a stateful process or protocol in order to implement a multiplayer variable skill objective wagering process. In an example embodiment, the multiplayer skill objective electronic gaming system provides a multiplayer skill objective in the form of a multiplayer skill-based game to two or more players and enters a multiplayer skill objective state O 1200. While the players are playing the multiplayer skill-based game, the multiplayer variable skill objective interactive gaming system may determine that at least one player has failed to achieve the multiplayer skill objective and the multiplayer variable skill objective interactive gaming system transitions from multiplayer skill objective state 1200 to intermediate loss state L1_{Pk} 1202.

While in the intermediate loss state L1_{Pk} 1202, the multiplayer variable skill objective interactive gaming system generates a variable skill objective in the form of a skill enhancer within the multiplayer skill-based game based on a random outcome during the players' skillful play of the multiplayer skill-based game and transitions, as indicated by probability P(Oᵥ) 1214, from the intermediate loss state L1_{Pk} 1202 to variable skill objective state Oᵥ 1206. If the at least one player is able to achieve the variable skill objective through successful utilization of the skill enhancer, then the multiplayer variable skill objective interactive gaming system transitions from variable objective state Oᵥ 1206 back to the multiplayer skill objective state O 1200 as indicated by transition probability P(A_{Ov}) 1220.

If the at least one player is not able to achieve the variable skill objective through successful utilization of the skill enhancer, then the multiplayer variable skill objective interactive gaming system transitions from variable objective state Oᵥ 1206 to final loss state L2_{Pk} 1204 as indicated by transition probability 1−P(A_{Ov}) 1224.

If the multiplayer variable skill objective interactive gaming system determines not to generate the variable skill objective, then the multiplayer variable skill objective interactive gaming system transitions to the final loss state L2_{Pk} 1204, as indicated by probability 1−P(Oᵥ) 1216.

While in the multiplayer skill objective state O 1200, if the multiplayer variable skill objective interactive gaming system determines that a player of the two or more players has successfully achieved the multiplayer skill objective, the multiplayer variable skill objective interactive gaming system transitions to the multiplayer skill objective achievement state A 1210, as indicated by transition OA_{Pj} 1218.

In many embodiments, the stateful process or protocol includes determining a commitment of an amount of credit to a wager during the multiplayer skill objective state O 1200, and determining an award of an amount of credit for the wager while in the multiplayer skill objective achievement state OA 1206.

In some embodiments, an amount of credits for a specified award of a skill objective is specified based on a random outcome.

In some embodiments, an amount of credits is specified based on a gaming parameter for one or more skill objectives during a wagering session as a specified award for the one or more skill objectives. In example embodiments, gaming parameters may include, but are not limited to, an amount of credits committed in a wager, an identity of a player, an amount of time that the player has been playing a multiplayer skill-based game, an amount of credits wagered over time, a location of an electronic gaming machine, etc.

In some embodiments, an amount of credits is fixed for one or more multiplayer skill objectives as a specified award for the one or more multiplayer skill objectives.

The wagering processes described herein may be combined in various ways to create wagering processes for various types of multiplayer skill-based games associated with multiplayer skill objectives of multiplayer wagering propositions. In an example embodiment, a multiplayer video game in the form of a maze chase style skill-based multiplayer competitive game is provided. Each player of two or more players controls a respective virtual player character that each player guides through a virtual maze. As each player character is guided through the maze, the player character collects in-game objects in order to score skill points for the respective player and to collect power ups that give the player characters enhanced capabilities such as faster speed or the ability to eliminate another player's player character from the multiplayer skill-based game. At least one multiplayer skill objective is for a player to eliminate all other players' player characters from the multiplayer skill-based game.

In some embodiments, a variable skill objective in the form of a skill disruptor is generated in the maze in order to disrupt a randomly selected player's respective player character. The skill disruptor only affects the randomly selected player's skillful play of the multiplayer skill-based game and does not affect the play of the other players. In an example embodiment, the skill disruptor is an automated non-player character that interferes with the randomly selected player's player character. The form of the interference can include, but is not limited to, blocking off portions of the maze, eliminating the player character from the game, chasing the player character, etc.

In various embodiments, a variable skill objective in the form of a skill enhancer is generated in the maze in order to enhance a randomly selected player's respective player character. The skill enhancer only affects the randomly selected player's skillful play of the multiplayer skill-based game and does not affect the play of the other players. In an example embodiment, the skill disruptor is an automated non-player character that assists the randomly selected player's player character. The form of the assistance can include, but is not limited to, blocking off portions of the maze so that other player characters cannot approach the randomly selected player's player character, providing a power up that enables the randomly selected player's player character to eliminate one or more other player characters from the game, etc.

In some embodiments, a variable skill objective in the form of a skill enhancer is generated as a restoration a player's player character after the player character has been eliminated from the game by another player's player character.

In various embodiments, at a beginning of a multiplayer game, a random outcome is generated using an RNG and the random outcome used to select a player and the selected player will receive a variable skill objective either in the form of a skill enhancer or a skill disruptor. In some such embodiments, a distribution of the random outcome is a normal distribution with the probability that any one player is selected as the selected player to receive the variable skill objective is 1/N where N is a number of the players playing the multiplayer game.

In some embodiments, one or more non-player characters are introduced into a multiplayer game and are controlled by algorithms that cause the non-player character to hinder a player's play of the multiplayer game as variable skill objectives for one or more players to achieve through avoiding the non-player's hindrance. The non-player character algorithms can be configured using non-player character attributed to make the non-player character more or less aggressive against the selected player. These non-player character attributes include, but are not limited to, a range at which the non-player character can detect a selected player, a speed at which the non-player character can move within a game world of the multiplayer game, an amount of virtual damage a non-player character can inflict on a selected player, etc. In an example embodiment, to make a non-player more aggressive toward a selected player, a range of detecting the selected player is increased, that is, the non-player character can detect the selected player and an increased range relative to other players in the multiplayer game. In another example embodiment, to make a non-player more aggressive toward a selected player, the non-player character's speed through a game world of the multiplayer game is increased when the non-player character moves toward the selected player. In another example embodiment, to make a non-player more aggressive toward a selected player, the non-player character's ability to inflict virtual damage on a selected player is increased as compared to other non-selected players.

In various embodiments, variable objectives in the form of skill enhancers are provided to players other than a selected player. That is, a selected player is disadvantaged as compared to other players of a multiplayer game as the selected player is not provided with same skill enhancers as the other players. In an example embodiment, a skill enhancer in the form of a power-up is provided to players of a multiplayer game. The power up can be created, or spawned, anywhere within a game world of the multiplayer game. The power-up is spawned in proximity to other players and not in proximity to the selected player. That is, power-ups spawn within the game world in locations where non-selected players may access the power-ups quickly, whereas the selected player may not be able to access the power-ups as quickly as the other players, thus causing a disadvantage to the selected player.

In some embodiments, a distribution of a random outcome used to select a player to be provided a variable skill objective is a weighted distribution and players' probabilities of being selected are weighted based on game performance. In an example embodiment, if a player has won 3 times in a row, then the player will be twice as likely to receive the variable skill objective, if 2 players have won 5 times in a row, then it will be twice as likely for one of these players to receive the variable skill objective, if 3 players have won 7 times in a row, it will be twice as likely for one of these players to receive the equalizer treatment, etc.

In some embodiments, a player is selected to receive a variable skill objective that is a skill disruptor based on previous gameplay. In several embodiments, at a beginning of a multiplayer game, a player is selected to receive a variable skill objective dependent on which player or players have won a majority of previous games. In an example embodiment, if one player has won over half of the games (after 3 or more games have been played) then that player will be selected to receive a variable skill objective in the form of a skill disruptor. In additional embodiments, if the selected player still won after being selected to receive the variable skill objective, they are selected again for a more intense variable skill objective treatment. In an example embodiment, a non-player character's algorithms are configured to with increases in aggressiveness, speed, etc. In various such embodiments, if two or more players have won between them over half of the games, then one of the two or more player them will be provided with a variable skill objective in the form of a skill disruptor based on a random outcome as described herein. The algorithm of assigning variable skill objectives repeats until no player or group of two or more players has won over half of the games played.

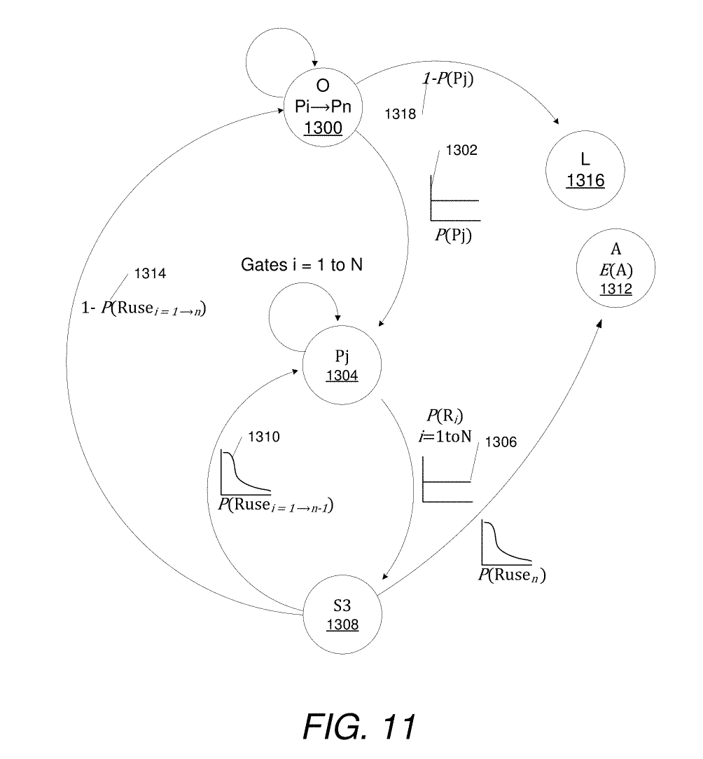

FIG. 11 is a state diagram illustrating another wagering process of a multiplayer variable skill objective wagering system in accordance with various embodiments of the invention. In a wagering process, two or more players attempt 1300 to achieve a multiplayer skill objective through skillful play. During skillful play by the two or more players, one or more players are selected at random to be presented with a series of one or more variable skill objectives having one or more gated resources that are utilized by the selected one or more players to achieve the one or more variable skill objectives. If the one or more players are able to achieve the one or more variable skill objectives using the one or more associated gated resources, the one or more players are awarded a specified award.

In the wagering process, the multiplayer variable skill objective interactive gaming system provides a multiplayer skill objective, as indicated by multiplayer skill objective state O 1300, that two or more players attempt to achieve, as indicated by P1→Pn of state O 1300. As the players attempt to achieve the multiplayer skill objective, at least one player, Pj, is randomly determined 1302 by the multiplayer variable skill objective interactive gaming system to be provided with one or more variable skill objectives associated with one or more gated resources, and the multiplayer variable skill objective interactive gaming system transitions to state Pj 1304.

While the multiplayer variable skill objective interactive gaming system is in state Pj 1304, the randomly determined one or more players attempt to achieve the one or more variable skill objectives. While attempting to achieve the one or more variable skill objectives, the one or more players utilize one or more resources. Additional resources are generated by the multiplayer variable skill objective interactive gaming system, or gated, to the player in accordance with a random outcome in a process termed resource gating. Each variable skill objective has associated with it one or more resource gates, as indicated by gates i=1 to N, whereby the player may have additional resources provided to the player while the player attempts to achieve the one or more variable skill objectives. Whether or not the one or more players receive the additional resources is dependent on a random outcome, as indicated by the probability that the player receives the game resource P(Ri), i=1→N 1306.

At each resource gate, the one or more players are provided with enough resources to continue to attempt to achieve the one or more variable skill objectives. If the player is provided with the resource, the multiplayer variable skill objective interactive gaming system transitions to state S3 1308. Each time the one or more players successfully use a gated resource but has not successfully achieved the variable skill objective, the multiplayer variable skill objective interactive gaming system transitions back to state Pj 1304, as indicated by P(R_{usei=1 to n-1}) 1310, where additional resources may be gated to the one or more players.

If the player successfully utilizes all of the gated resources, and thereby also completes the achievement of the one or more variable skill objectives, the multiplayer variable skill objective interactive gaming system transitions to a state A 1312 and player earns a specified award.

If the player is unable to successfully utilize the game resources, as indicated by 1−P(R_{usei=1 to n}) 1314, the multiplayer variable skill objective interactive gaming system transitions back to state O 1300 where the one or more players continue to attempt to achieve the multiplayer skill objective where the one or more players may or may not be randomly determined again to be provided with a variable skill objective and receive additional resources from a resource gate.

If a player is not randomly determined to be provided with the variable skill objective, then that player will eventually fail to achieve the multiplayer skill objective as well, and the multiplayer variable skill objective interactive gaming system transitions to a state L 1316. The probability of the player not being randomly determined to be provided with the variable skill objective is then 1−P(Pj) 1318.

In many embodiments, the probability that a player will be both randomly determined to be provided with a variable skill objective and receive resources from a resource gate and actually receive the resource is much less than one, that is P(Pk)*P(Ri)<<1.0, while the probability that the player will be able to successfully utilize the resource to achieve the variable skill objective is very high, that is P(Rusei) 1.0. Accordingly, the probability that a player will receive a resource and be successful in using the resource to achieve a variable skill objective is primarily controlled by whether or not the player is randomly determined and/or received the resource, that is the probability of the player achieving the variable skill objective is approximately P(Pk)*P(Ri). More specifically:

$$P ( Oi achieved ) = P ( Pj ) * {\sum }_{k = s}^{n} ( \begin{matrix}n \\ k\end{matrix} ) {P ( R )}^{k} {( 1 - P ( R ) )}^{n - k}$$

Where:

P(Oi achieved)=probability that a player Pj will have achieved a variable skill objective i, Oi.

P(Pj)=probability that player j is determined to be provided with the variable skill objective.

n=number of resource gates.

k=number of generations game resources.

s=number of generation of resources needed to achieve the objective, Oi.

P(R)=probability of resource being generated.

During operation, a multiplayer variable skill objective interactive gaming system implements a stateful process or protocol in order to implement a multiplayer variable skill objective wagering process. In an example embodiment, the multiplayer skill objective electronic gaming system provides a multiplayer skill objective in the form of a multiplayer skill-based game to two or more players and enters a multiplayer skill objective state O 1300. As the players attempt to achieve the multiplayer skill objective, at least one player, Pj, is randomly determined by the multiplayer variable skill objective interactive gaming system to be provided with one or more variable skill objectives associated with one or more gated resources, and the multiplayer variable skill objective interactive gaming system transitions to state Pj.

While the multiplayer variable skill objective interactive gaming system is in state Pj, the randomly determined one or more players attempt to achieve the one or more variable skill objectives. While attempting to achieve the one or more variable skill objectives, the one or more players utilize one or more resources. Additional resources are generated by the multiplayer variable skill objective interactive gaming system in accordance with a random outcome. Each variable skill objective has associated with it one or more resource gates, as indicated by gates i=1 to N, whereby the player may have additional resources provided to the player while the player attempts to achieve the one or more variable skill objectives. Whether or not the one or more players receive the additional resources is dependent on a random outcome, as indicated by the probability that the player receives the game resource P(Ri), i=1→N.

At each resource gate, if the multiplayer variable skill objective interactive gaming system determines to generate the resource, the multiplayer variable skill objective interactive gaming system transitions to state S3. Each time the one or more players successfully use a gated resource but has not successfully achieved the variable skill objective, the multiplayer variable skill objective interactive gaming system transitions back to state Pk, as indicated by P(R_{usei=1 to n-1}), where additional resources may be gated to the one or more players.

If the player successfully utilizes all of the gated resources, and thereby also completes the achievement of the one or more variable skill objectives, the multiplayer variable skill objective interactive gaming system transitions to a state A and player earns a specified award.

If the player is unable to successfully utilize the game resources, as indicated by 1−P(R_{usei=1 to n}), the multiplayer variable skill objective interactive gaming system transitions back to state O 1300 where the one or more players continue to attempt to achieve the multiplayer skill objective where the one or more players may or may not be randomly determined again to be provided with a variable skill objective and receive additional resources from a resource gate.

If a player is not randomly determined to be provided with the variable skill objective, then that player will eventually fail to achieve the multiplayer skill objective as well, and the multiplayer variable skill objective interactive gaming system transitions to a state L. The probability of the player not being randomly determined to be provided with the variable skill objective is then 1−P(Pj).

In many embodiments, the stateful process or protocol includes determining a commitment of an amount of credit to a wager during the multiplayer skill objective state O 1300, and determining an award of an amount of credit for the wager while in the multiplayer skill objective achievement state A.

In some embodiments, an amount of credits for a specified award of associated with a skill objective is specified based on a random outcome.

In some embodiments, an amount of credits is specified based on a gaming parameter for one or more skill objectives during a wagering session as a specified award for the one or more skill objectives. In example embodiments, gaming parameters may include, but are not limited to, an amount of credits committed in a wager, an identity of a player, an amount of time that the player has been playing a multiplayer skill-based game, an amount of credits wagered over time, a location of an electronic gaming machine, etc.

In some embodiments, an amount of credits is fixed for one or more skill objectives as a specified award for the one or more skill objectives.

In an example embodiment, a multiplayer skill objective is provided in the form of a skill-based game that is a multiplayer first person shooter game having two or more players. The multiplayer skill objective is for a player to survive the skill-based game by defeating all of the other players of the two or more players. A variable skill objective is provided to a player in the form of a side-mission or goal. In an example embodiment, a variable skill objective to be achieved by a player is to defeat 12 other opponents using a virtual gun holding 6 virtual rounds. If the player confronts an opponent but fails to defeat that opponent, the player may be eliminated from the multiplayer skill-based game by that opponent, and thus the player fails to achieve the multiplayer skill objective. The player is to be provided fresh virtual guns at resource gates. In reference to the above equation, a resource is a fresh virtual gun, accordingly s, the number of resource generations needed to complete the objective, is 2. At each resource gate, the probability that a fresh virtual gun will be generated is 0.5. If the player survives long enough to get to only 1 resource gate, the player has no chance to achieve the variable skill objective. If the player manages to get to 3 or more resource gates, the player will have a high probability of getting enough fresh virtual guns to complete the variable skill objective of using the virtual gun to defeat 12 opponents.

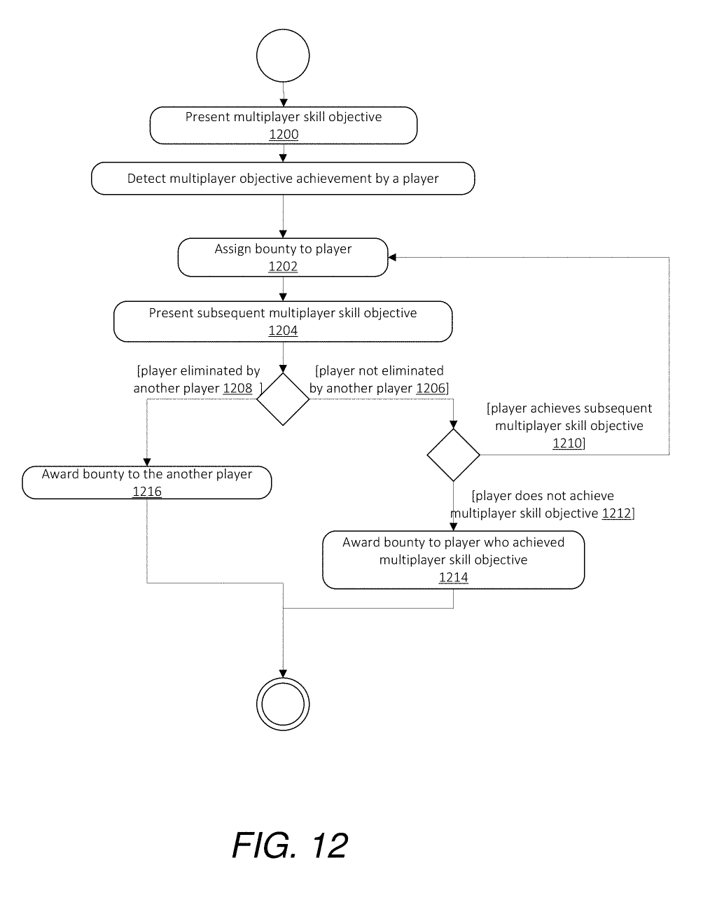

FIG. 12 is an activity diagram of a skill equalizing process of a multiplayer variable skill objective wagering system in accordance with various embodiments of the invention. In many embodiments of a multiplayer variable skill objective wagering system, two or more multiplayer skill objectives are presented 1200 to three or more players wherein achievement of the multiplayer skill objective includes defeating other players in direct player vs. player or head-to-head interactions. In an example embodiment, the three or more players play an interactive multiplayer chase game wherein the players may obtain a power-up that allows a player's character to directly eliminate another player's character that has not obtained a similar power up.

When an individual player achieves a string of multiplayer skill objectives, (1-n) a bounty is placed on that player. In various embodiments, the bounty may be in the form of, but not limited to, a random award determined using a random outcome and a paytable, a fixed award, an escalating fixed award, a random award with escalating fixed value, etc. If the player with the bounty is eliminated 1208 by another player, the another player responsible is awarded 1216 the bounty. If the player with the bounty is eliminated by some other process without being affected by another player, the player who achieves a current multiplayer skill objective is awarded 1214 the bounty. If the player is not eliminated and that player achieves 1210 the subsequent multiplayer skill objective, the multiplayer variable skill objective wagering system again assigns 1200 a bounty to the player and presents 1204 another subsequent multiplayer skill objective to the plurality of players.

If the player is not eliminated by another player, and the player also does not achieve the subsequent multiplayer skill objective 1212, the multiplayer variable skill objective wagering system awards 1214 the bounty to whichever player has achieved the multiplayer skill objective.

In some embodiments, a multiplayer variable skill objective wagering system presents a multiplayer skill objective to a plurality of players. The multiplayer variable skill objective wagering system multiplayer variable skill objective wagering system detects that a player of the plurality of players has achieved the multiplayer skill objective and assigns a bounty to that player. The multiplayer variable skill objective wagering system presents a subsequent multiplayer skill objective to the plurality of players. If the player who achieved the first presented multiplayer skill objective is eliminated by another player, the multiplayer variable skill objective wagering system awards the assigned bounty to the another player.

In some embodiments, the bounty is randomly assigned to a player.

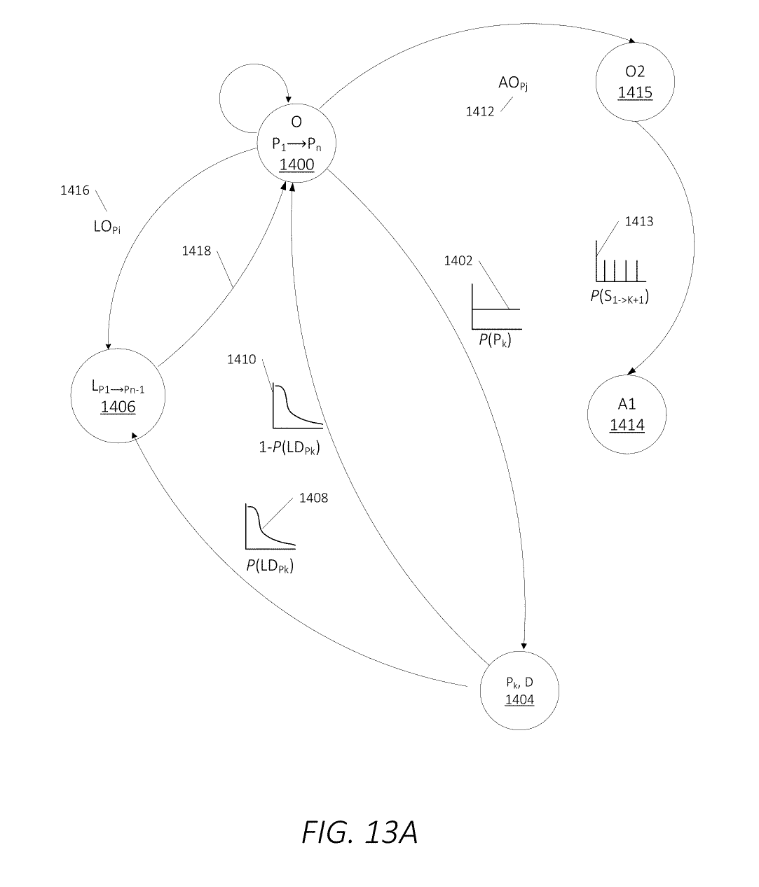

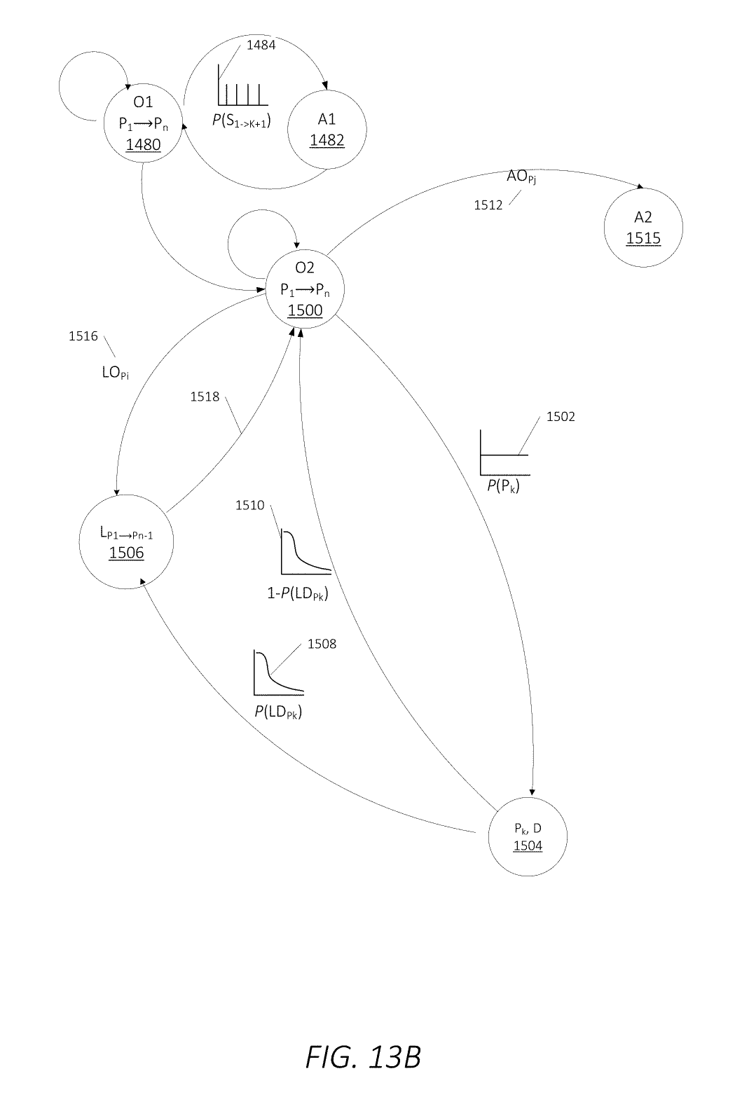

FIG. 13A is a state diagram illustrating a wagering process having an auxiliary objective of a multiplayer variable skill objective interactive gaming system in accordance with various embodiments of the invention. In such a wagering process, a multiplayer interactive application of the multiplayer variable skill objective interactive gaming system implements a multiplayer wagering proposition having a multiplayer skill objective as described herein. During the wagering process, two or more players attempt to achieve the multiplayer skill objective. While the two or more players attempt to achieve the multiplayer skill objective, a variable skill objective in the form of a skill disruptor is randomly generated during the wagering process such that the skill disruptor lowers the probability that at least one of the players will be able to achieve the multiplayer skill objective of the multiplayer wagering proposition.

In the wagering process, the multiplayer wagering proposition includes a multiplayer skill objective, as indicated by state O 1400, that each player of the two or more players, as indicated by P₁->Pₙ, attempts to achieve. As the two or more players attempt to achieve the multiplayer skill objective, at least one player of the two or more players, indicated as Pₖ, is determined at random, as indicated by probability P(Pₖ) 1402, to receive a variable skill objective in the form of a skill disruptor as described herein. The wagering process then transitions to state Pₖ, D 1404 in which the at least one player attempts to achieve the variable skill objective of overcoming skill disruptor through skillful play.

The at least one player, Pₖ, may fail to overcome the skill disruptor, that is the at least one player may not be able to achieve the variable skill objective of overcoming the skill disruptor, leading to a loss by the at least one player, Pk, and the multiplayer variable skill objective interactive gaming system transitions to state L_{P1->Pn-1} 1406. The probability of the at least one player failing to overcome the skill disruptor, and thus the probability of the wagering process transitioning from state Pk, D, 1404 to state L_{P1->Pn-1} 1406, is P(LD_{Pk}) 1408.

If the at least one player is able to overcome the skill disruptor, the multiplayer variable skill objective interactive gaming system transitions to state O 1400 where the at least one player Pₖ continues to attempt to achieve the multiplayer skill objective along with any remaining players of the two or more players. The probability that the at least one player is able to overcome the skill disruptor is the complement of the probability of not overcoming the skill disruptor, namely 1−P(LD_{Pk}) 1410.

While the wagering process is in state O 1400, each remaining player of the two or more players attempts to achieve the multiplayer skill objective. If a player, Pᵢ, of the two or more players lacks the skill needed to achieve the multiplayer skill objective, the multiplayer variable skill objective interactive gaming system transitions, as indicated by LO_{Pi} 1416, to state L_{P1->Pn-1} 1406 and player Pᵢ is no longer able to continue to attempt to achieve the multiplayer skill objective. The multiplayer variable skill objective interactive gaming system transitions 1418 from sate L_{P1->Pn-1} 1406 to sate O 1400 where any remaining players of the two or more players continue to attempt to achieve the multiplayer skill objective.

If a player, Pⱼ, of the two or more players is able to achieve the multiplayer skill objective, the multiplayer variable skill objective interactive gaming system transitions, as indicated by AO_{Pj}, 1412, to state A 1414 where player Pⱼ is awarded a specified award E(V).

In some embodiments, a probability, P(LO_{Pi}), that a player, Pᵢ, of the two or more players will fail to achieve the multiplayer skill objective because of player Pᵢ's poor skillful play may be determined by comparison of player Pᵢ's skillful play to the skillful play of the other players of the two or more players using a skill metric collected as the two or more players attempt to achieve the multiplayer skill objective. In addition, a probability, P(AO_{Pj}), that a player, Pj, will achieve the multiplayer skill objective because of player Pⱼ's skillful play may be determined by comparison of player Pᵢ's skillful play to the skillful play of the other players of the two or more players using a skill metric collected as the two or more players attempt to achieve the multiplayer skill objective. In such a case, the probability that player Pⱼ will be able to achieve the multiplayer skill objective of state O 1400 in the absence of a skill disruptor is 1/n where n is the number players attempting to achieve the multiplayer skill objective. Accordingly, the probability that player Pᵢ fails to achieve the multiplayer skill objective is the complement of the probability of player Pⱼ achieving the multiplayer skill objective, that is 1−1/n or (n−1)/n.

In various embodiments, a probability that a player will lose because of the player's inability to overcome the skill disruptor, P(LD_{Pk}) 1408, can be determined from historical player skill metrics collected while attempting to overcome the skill disruptor. The probability that any player will be able to skillfully overcome the skill disruptor, and thus cause a transition from state Pk, D 1404, back to state O 1400, is then 1−P(LD_{Pk}) 1410.

It can be seen by inspection that if the probability, P(LO_{Pk}), is high that a specific player, Pₖ, will be able to achieve the multiplayer skill objective of the multiplayer wagering proposition through skillful play, the probability, P(AO_{Pk}) that player Pₖ will be able to achieve the multiplayer skill objective, and thus be awarded the specified award, is dependent upon the probability, P(Pₖ), that player Pₖ is determined to be the player to whom the skill disruptor is provided and the probability, P(LD_{Pk}), that player Pₖ will not be able to overcome the skill disruptor. Furthermore, if P(LD_{Pk}) is unity, that is there is no way for player Pₖ to overcome the skill disruptor once the skill disruptor is generated, the probability that player Pₖ will be able to achieve the multiplayer skill objective is mostly dependent upon the probability that player Pₖ is determined to receive the skill disruptor. That is, as P(LO_{Pk})⇒0 and P(LD_{Pk})⇒1, then P(AO_{Pk})⇒0, that is for a skillful player, the probability of achieving the multiplayer skill objective without the introduction of the skill disruptor is high and the probability not achieving the multiplayer skill objective with the introduction of the skill disruptor is low.

During operation, a multiplayer variable skill objective interactive gaming system implements a stateful process or protocol in order to implement a multiplayer wagering proposition having a skill disruptor. In an example embodiment, the multiplayer variable skill objective interactive gaming system executes a multiplayer interactive application that presents a multiplayer skill-based game to two or more players and enters a multiplayer skill objective state O 1400 where the two or more players attempt to achieve a multiplayer skill objective of the multiplayer skill-based game. While in the multiplayer skill objective state O 1400, the multiplayer variable skill objective interactive gaming system determines at least one player of the two more players too which a skill objective in the form of a skill disruptor will be provided on the basis of a random outcome. The skill disruptor is generated within the multiplayer skill-based game based on a random outcome during the players' skillful play of the multiplayer skill-based game. The multiplayer variable skill objective interactive gaming system transitions, as indicated by probability P(Pk) 1402, from the multiplayer skill objective state O 1400 to a skill disruptor state Pk, D, 1404. While in the skill disruptor state Pk, D 1404, the multiplayer variable skill objective interactive gaming system determines if the at least one player has overcome the skill disruptor through skillful play of the multiplayer skill-based game. In other words, the multiplayer variable skill objective interactive gaming system determines if the at least one player has been able to achieve a skill objective of overcoming the skill disruptor through skillful play of the multiplayer.

When multiplayer variable skill objective interactive gaming system determines that the at least one player has not been able to overcome the skill disruptor, the multiplayer variable skill objective interactive gaming system transitions to a loss state Pk, L 1406 as indicated by probability P(LD_{Pk}) 1408.

When the multiplayer variable skill objective interactive gaming system determines that the player has been able to overcome the skill disruptor, that is achieve the skill objective represented by the skill disrupter, the multiplayer variable skill objective interactive gaming system transitions to multiplayer skill objective state O 1400 as indicated by probability 1−P(LD_{Pk}) 1410.

In the multiplayer skill objective state O 1400, the multiplayer variable skill objective interactive gaming system determines if the at least one player is unable to achieve a multiplayer skill objective. If the multiplayer variable skill objective interactive gaming system determines that the at least one player has not been able to achieve the multiplayer skill objective, the multiplayer variable skill objective interactive gaming system transitions to the loss state Pk, L 1406 as indicated by probability P(LO_{Pk}) 1412. If the multiplayer variable skill objective interactive gaming system determines that the player has been able to achieve the multiplayer skill objective, then the multiplayer variable skill objective interactive gaming system transitions, as indicated by transition AOPj 1412 to auxiliary objective state O2 1415. In auxiliary objective state O2 one or more chance-based outcomes are associated with one or more auxiliary interactive objectives. The one or more auxiliary objectives are presented to the player and the player makes a selection of at least one of the auxiliary interactive objectives and the auxiliary objective interactive wagering system transitions to award state A1 1414 as indicated by player-selection transition 1413 with a probability P(S_{1->K+1}) indicating the probability that the player will select a particular auxiliary objective. In state A1 the interactive wagering system determines an award of credits to award to the player based on the chance-based outcome associated with the detected player selection of at least one of the one or more auxiliary interactive objectives.

In some embodiments, at the initiation of a wagering process, the two or more players select a chance-based outcome that is associated with achievement of the multiplayer skill objective. In some embodiments, values of the selected chance-based outcomes are hidden from the two or more players during the interactive selection process. In some embodiments, the values of the selected chance-based outcomes are displayed to the two or more players during the interactive selection process.

FIG. 13B is a state diagram illustrating a wagering process having an auxiliary objective of a multiplayer variable skill objective interactive gaming system in accordance with various embodiments of the invention. In such a wagering process, a multiplayer interactive application of the multiplayer variable skill objective interactive gaming system implements a multiplayer wagering proposition having a multiplayer skill objective as described herein.

At the initiation of a wagering process, two or more players select a chance-based outcome that is associated with achievement of the multiplayer skill objective. In some embodiments, values of the selected chance-based outcomes are hidden from the two or more players during the interactive selection process. In some embodiments, the values of the selected chance-based outcomes are displayed to the two or more players during the interactive selection process.

During the wagering process, the two or more players attempt to achieve the multiplayer skill objective. While the two or more players attempt to achieve the multiplayer skill objective, a variable skill objective in the form of a skill disruptor is randomly generated during the wagering process such that the skill disruptor lowers the probability that at least one of the players will be able to achieve the multiplayer skill objective of the multiplayer wagering proposition. When a player achieves the multiplayer skill objective, the player is awarded the player's respective selected chance-based outcome.

At the initiation of the wagering process, as indicated by state O1 1480, two or more players each select a respective chance-based outcome, as indicated by player selection transition 1484 and state A1 1482. The respective chance-based outcomes are associated with achievement of the multiplayer skill objective. In some embodiments, values of the selected chance-based outcomes are hidden from the two or more players during the interactive selection process. In some embodiments, the values of the selected chance-based outcomes are displayed to the two or more players during the interactive selection process.

the multiplayer wagering proposition includes a multiplayer skill objective, as indicated by state O2 1500, that each player of the two or more players, as indicated by P₁->Pₙ, attempts to achieve. As the two or more players attempt to achieve the multiplayer skill objective, at least one player of the two or more players, indicated as Pₖ, is determined at random, as indicated by probability P(Pₖ) 1502, to receive a variable skill objective in the form of a skill disruptor as described herein. The wagering process then transitions to state Pₖ, D 1504 in which the at least one player attempts to achieve the variable skill objective of overcoming skill disruptor through skillful play.

The at least one player, Pₖ, may fail to overcome the skill disruptor, that is the at least one player may not be able to achieve the variable skill objective of overcoming the skill disruptor, leading to a loss by the at least one player, Pk, and the multiplayer variable skill objective interactive gaming system transitions to state L_{P1->Pn-1} 1506. The probability of the at least one player failing to overcome the skill disruptor, and thus the probability of the wagering process transitioning from state Pk, D, 1504 to state L_{P1->Pn-1} 1506, is P(LD_{Pk}) 1508.

If the at least one player is able to overcome the skill disruptor, the multiplayer variable skill objective interactive gaming system transitions to state O2 1500 where the at least one player Pₖ continues to attempt to achieve the multiplayer skill objective along with any remaining players of the two or more players. The probability that the at least one player is able to overcome the skill disruptor is the complement of the probability of not overcoming the skill disruptor, namely 1−P(LD_{Pk}) 1510.

While the wagering process is in state O2 1500, each remaining player of the two or more players attempts to achieve the multiplayer skill objective. If a player, Pᵢ, of the two or more players lacks the skill needed to achieve the multiplayer skill objective, the multiplayer variable skill objective interactive gaming system transitions, as indicated by LO_{Pi} 1516, to state L_{P1->Pn-1} 1506 and player Pᵢ is no longer able to continue to attempt to achieve the multiplayer skill objective. The multiplayer variable skill objective interactive gaming system transitions 1518 from sate L_{P1->Pn-1} 1506 to sate O2 1500 where any remaining players of the two or more players continue to attempt to achieve the multiplayer skill objective.

If a player, Pⱼ, of the two or more players is able to achieve the multiplayer skill objective, the multiplayer variable skill objective interactive gaming system transitions, as indicated by AO_{Pj}, 1512, to state A2 1515 where player Pⱼ is awarded the player's respective selected chance-based outcome and the chance-based award is revealed to the player.

In some embodiments, a probability, P(LO_{Pi}), that a player, Pᵢ, of the two or more players will fail to achieve the multiplayer skill objective because of player Pᵢ's poor skillful play may be determined by comparison of player Pᵢ's skillful play to the skillful play of the other players of the two or more players using a skill metric collected as the two or more players attempt to achieve the multiplayer skill objective. In addition, a probability, P(AO_{Pj}), that a player, Pj, will achieve the multiplayer skill objective because of player Pⱼ's skillful play may be determined by comparison of player Pᵢ's skillful play to the skillful play of the other players of the two or more players using a skill metric collected as the two or more players attempt to achieve the multiplayer skill objective. In such a case, the probability that player Pⱼ will be able to achieve the multiplayer skill objective of state O2 1500 in the absence of a skill disruptor is 1/n where n is the number players attempting to achieve the multiplayer skill objective. Accordingly, the probability that player Pᵢ fails to achieve the multiplayer skill objective is the complement of the probability of player Pⱼ achieving the multiplayer skill objective, that is 1−1/n or (n−1)/n.

In various embodiments, a probability that a player will lose because of the player's inability to overcome the skill disruptor, P(LD_{Pk}) 1508, can be determined from historical player skill metrics collected while attempting to overcome the skill disruptor. The probability that any player will be able to skillfully overcome the skill disruptor, and thus cause a transition from state Pk, D 1504, back to state O2 1500, is then 1−P(LD_{Pk}) 1510.

It can be seen by inspection that if the probability, P(LO_{Pk}), is high that a specific player, Pₖ, will be able to achieve the multiplayer skill objective of the multiplayer wagering proposition through skillful play, the probability, P(AO_{Pk}) that player Pₖ will be able to achieve the multiplayer skill objective, and thus be awarded the specified award, is dependent upon the probability, P(Pₖ), that player Pₖ is determined to be the player to whom the skill disruptor is provided and the probability, P(LD_{Pk}), that player Pₖ will not be able to overcome the skill disruptor. Furthermore, if P(LD_{Pk}) is unity, that is there is no way for player Pₖ to overcome the skill disruptor once the skill disruptor is generated, the probability that player Pₖ will be able to achieve the multiplayer skill objective is mostly dependent upon the probability that player Pₖ is determined to receive the skill disruptor. That is, as P(LO_{Pk})⇒0 and P(LD_{Pk})⇒1, then P(AO_{Pk})⇒0, that is for a skillful player, the probability of achieving the multiplayer skill objective without the introduction of the skill disruptor is high and the probability not achieving the multiplayer skill objective with the introduction of the skill disruptor is low.

During operation, a multiplayer variable skill objective interactive gaming system implements a stateful process or protocol in order to implement a multiplayer wagering proposition having a skill disruptor. In an example embodiment, the multiplayer variable skill objective interactive gaming system executes a multiplayer interactive application that presents a multiplayer skill-based game to two or more players and enters a multiplayer skill objective state O2 1500 where the two or more players attempt to achieve a multiplayer skill objective of the multiplayer skill-based game. While in the multiplayer skill objective state O2 1500, the multiplayer variable skill objective interactive gaming system determines at least one player of the two more players too which a skill objective in the form of a skill disruptor will be provided on the basis of a random outcome. The skill disruptor is generated within the multiplayer skill-based game based on a random outcome during the players' skillful play of the multiplayer skill-based game. The multiplayer variable skill objective interactive gaming system transitions, as indicated by probability P(Pk) 1502, from the multiplayer skill objective state O2 1500 to a skill disruptor state Pk, D, 1504. While in the skill disruptor state Pk, D 1504, the multiplayer variable skill objective interactive gaming system determines if the at least one player has overcome the skill disruptor through skillful play of the multiplayer skill-based game. In other words, the multiplayer variable skill objective interactive gaming system determines if the at least one player has been able to achieve a skill objective of overcoming the skill disruptor through skillful play of the multiplayer.

When multiplayer variable skill objective interactive gaming system determines that the at least one player has not been able to overcome the skill disruptor, the multiplayer variable skill objective interactive gaming system transitions to a loss state Pk, L 1506 as indicated by probability P(LD_{Pk}) 1508.

When the multiplayer variable skill objective interactive gaming system determines that the player has been able to overcome the skill disruptor, that is achieve the skill objective represented by the skill disrupter, the multiplayer variable skill objective interactive gaming system transitions to multiplayer skill objective state O2 1500 as indicated by probability 1−P(LD_{Pk}) 1510.

In the multiplayer skill objective state O2 1500, the multiplayer variable skill objective interactive gaming system determines if the at least one player is unable to achieve a multiplayer skill objective. If the multiplayer variable skill objective interactive gaming system determines that the at least one player has not been able to achieve the multiplayer skill objective, the multiplayer variable skill objective interactive gaming system transitions to the loss state Pk, L 1506 as indicated by probability P(LO_{Pk}) 1512. If the multiplayer variable skill objective interactive gaming system determines that the player has been able to achieve the multiplayer skill objective, then the multiplayer variable skill objective interactive gaming system transitions, as indicated by transition AOPj 1512 to state A2 1515 where the interactive wagering system determines an award of credits to award to the player based on the chance-based outcome associated with the detected player selection of a chance-based outcome and the value of the chance-based outcome is revealed to the player.

In some embodiments, selection of chance-based outcomes by one or more players occurs after achievement of the multiplayer skill objective. In some embodiments, values of the selected chance-based outcomes are hidden from the two or more players during the interactive selection process. In some embodiments, the values of the selected chance-based outcomes are displayed to the two or more players during the interactive selection process.

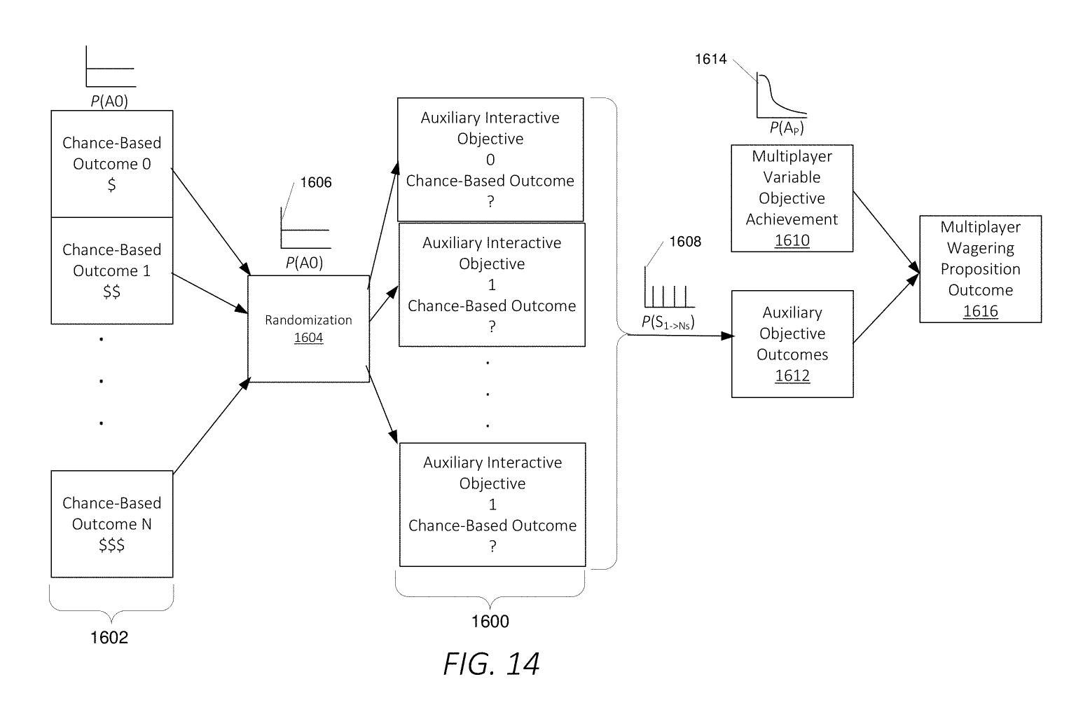

FIG. 14 is a data flow diagram of an auxiliary objective wagering process of a multiplayer variable skill objective interactive gaming system in accordance with various embodiments of the invention. As illustrated, two or more interactive objective achievements 1600 are associated with two or more chance-based outcomes 1602, each indexed as 0 to N. In some embodiments, the chance-based outcomes are sorted in increasing order of value, as indicated by the double and triple dollar signs of the chance-based outcomes. An order of the two or more chance-based outcomes associated with the two or more interactive subobjectives are randomized 1604 as indicated by a random-based transition P(AO) 1606. The two or more auxiliary interactive objectives are presented to a plurality of players with a value of each of the chance based outcomes concealed from the players and each player selects at least one of the auxiliary interactive objectives, as indicated by a player selection transition P(S1->Ns) 1608. For each player, their respective selected auxiliary interactive objective and associated chance-based outcome will become that player's respective auxiliary objective outcome 1612 if that player is successful in playing the multiplayer variable skill objective interactive game. The two or more players play the multiplayer variable skill objective interactive game and at least one player achieves a multiplayer variable objective achievement 1610 as indicated by player skill transition P(Ap) 1614. The chance-based outcome associated with the selected at least one auxiliary interactive objective is awarded to the achieving player as a multiplayer wagering proposition outcome 1616.

In some embodiments, two or more players play a maze chase game as described herein. Before the beginning of the maze chase game, that is before the players have played the game and a winner has been determined, the gaming system generates two or more chance-based outcomes of an amount of credits. The amounts of the chance-based outcomes are shown briefly to the players and then hidden in respective symbols that are randomized and redisplayed to the two or more players. Each of the two or more players makes a selection of a symbol hiding the chance-based outcomes. At an end of the multiplayer game, that is when a player has been determined to be the winner, the amount of chance-based outcomes are is hidden but presented to each player as an outcome of a game of chance such as a “wheel of fortune” style single spinning wheel. In some embodiments, the chance-based outcome is presented to the player as an outcome of a slot machine style set of one or more spinning reels.

In an example embodiment, two or more players play a maze chase game as described herein. At the conclusion of the maze chase game, that is when a player has been determined to be a winner, the gaming system generates a chance-based outcome of an amount of credits. The chance-based outcome is presented to the player as an outcome of a game of chance such as a “wheel of fortune” style single spinning wheel. In some embodiments, the chance-based outcome is presented to the player as an outcome of a slot machine style set of one or more spinning reels.

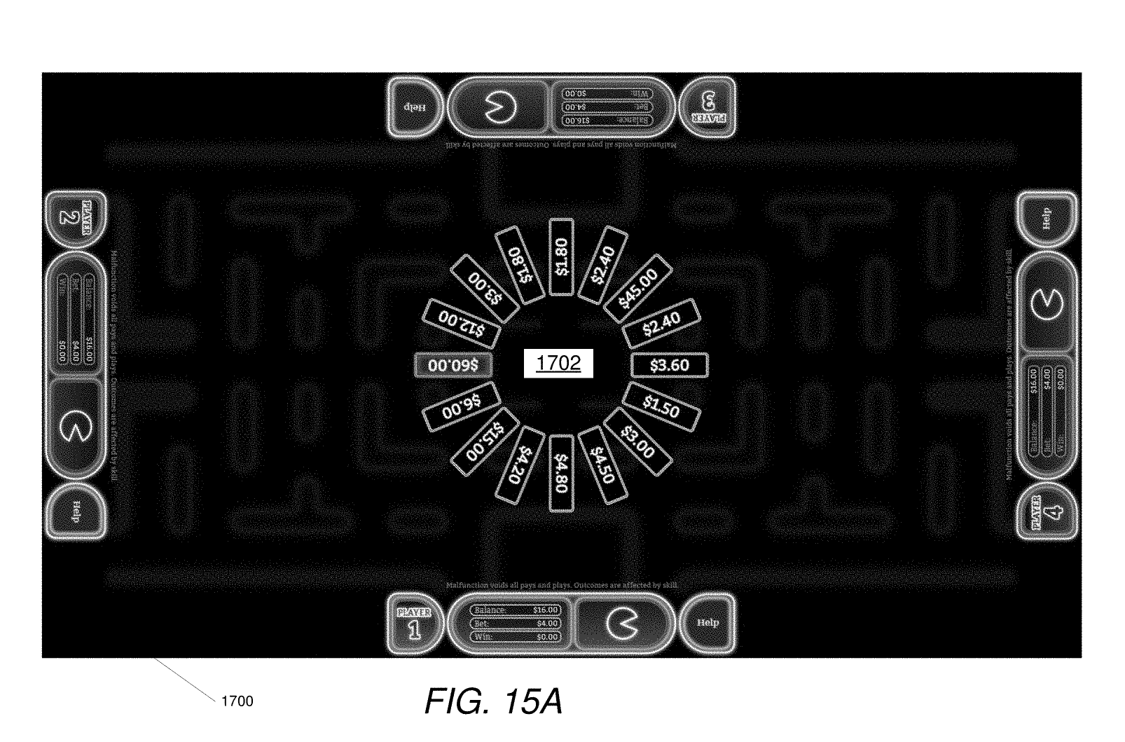

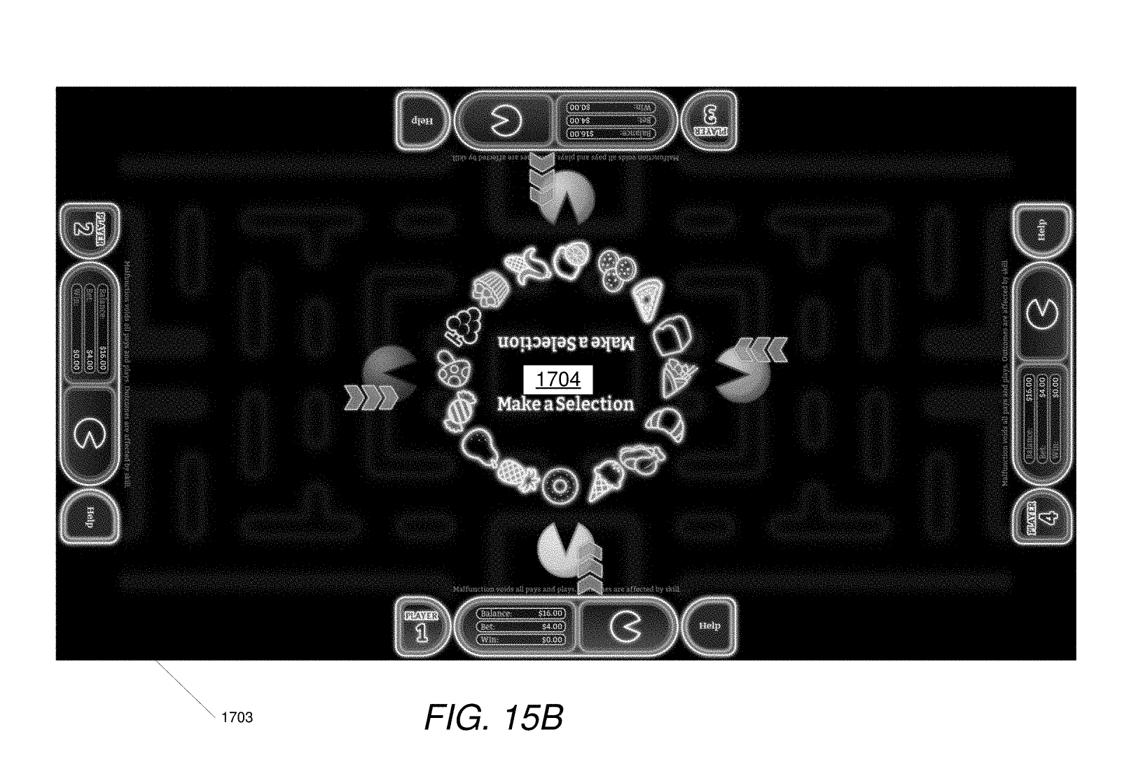

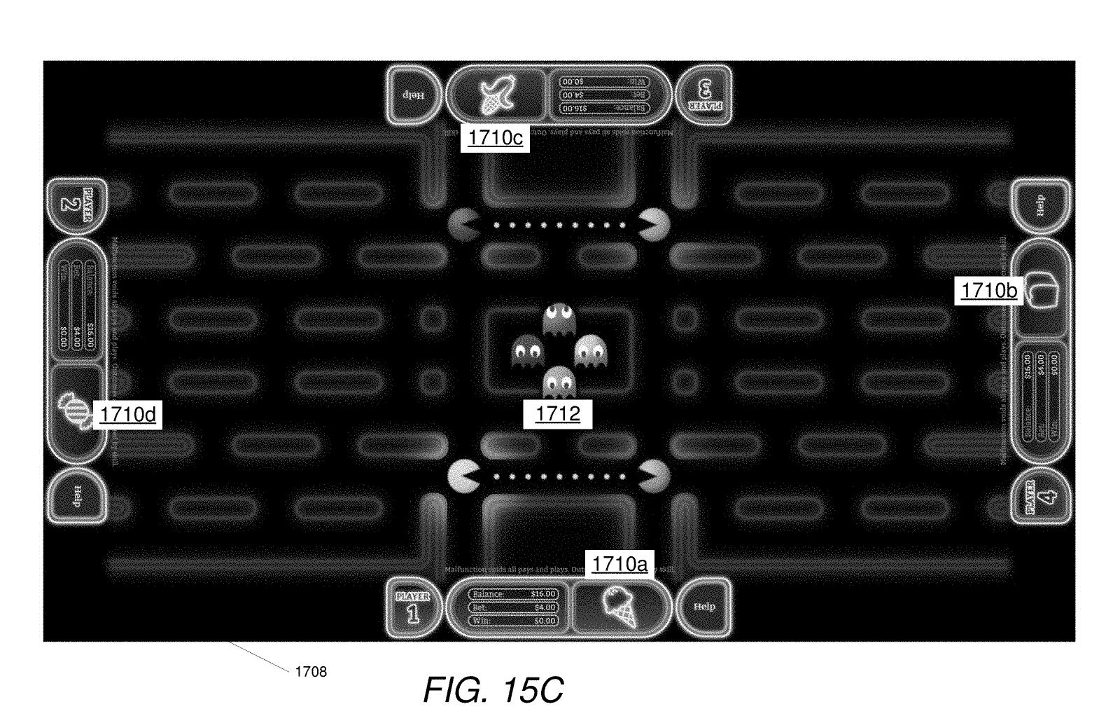

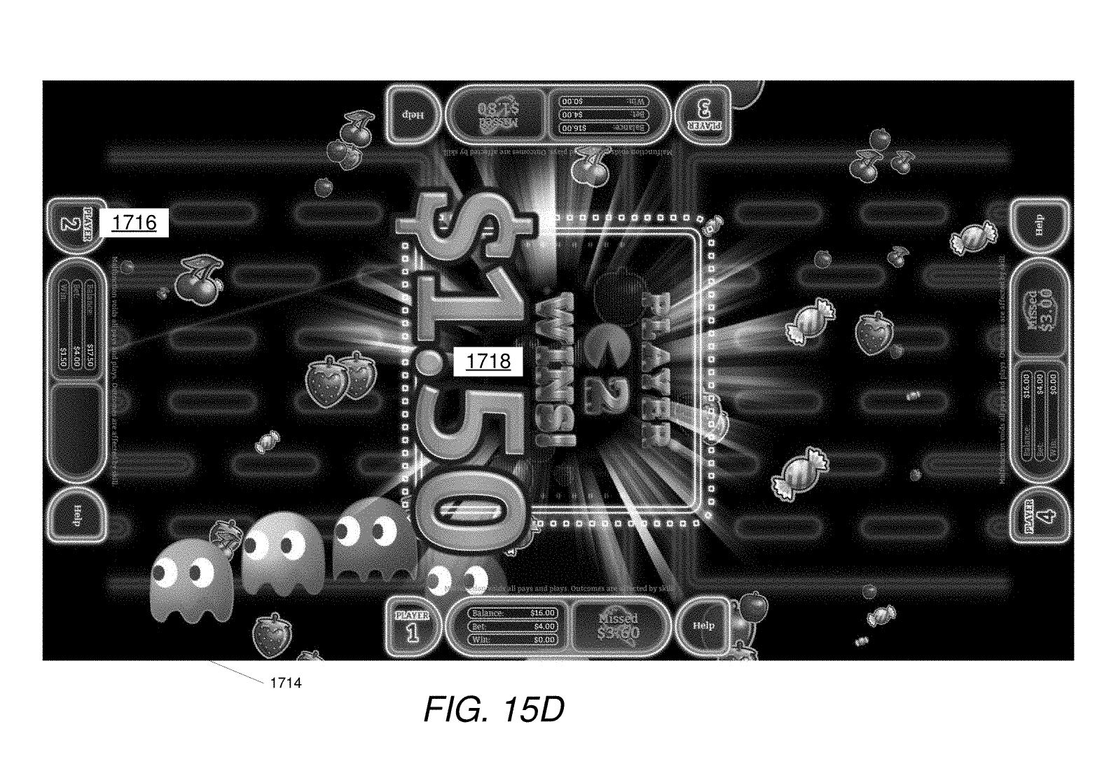

FIGS. 15A to 15D are illustrations of a user interface of a multiplayer variable skill objective interactive gaming system in accordance with various embodiments of the invention.

Referring now to FIG. 15A, a user interface 1700 illustrates a set of chance-based outcomes 1702 arranged in a spoke and wheel pattern. In some embodiments, one or more of the chance-based outcomes may be highlighted in order to emphasize a possible maximum chance-based outcome value.

In FIG. 15B, a user interface 1703 is illustrated wherein the chance-based outcomes have been randomized in order and are now hidden as a set of fruit symbols arranged in a slowly rotating ring of edible treat symbols 1704. Each player is prompted to make a selection of a treat symbol as a chance-based outcome that will be awarded to the player if the player achieves the multiplayer skill objective and each selected chance-based outcome will be associated with each respective player.

Referring now to FIG. 15C, a user interface 1708 is illustrated wherein the two or more players play a maze chase game and attempt to eliminate each other as a presented multiplayer skill objective. Each players' selected treat symbol representing a potential chance-based outcome to be awarded to the player for achieving the multiplayer skill objective is displayed at each player's respective station 1710a, 1710b, 1710c, 1710d. In the illustrated embodiment, skill disruptors in the form of ghosts 1712 are being used to interfere with one or more of the players.

Referring to FIG. 15D, a user interface 1714 illustrates a player, in this case player 2 1716, has achieved the multiplayer skill objective and the chance-based outcome is displayed 1718 to the player.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A multiplayer variable skill objective electronic gaming machine, comprising:
an interactive controller constructed to:
generate a multiplayer presentation based on a multiplayer wagering proposition;
detect player interactions of two or more players with the multiplayer presentation;
determine a multiplayer skill objective achievement based on the player interactions; and
communicate the multiplayer skill objective achievement to the process controller; and
the process controller operatively connected to the interactive controller, wherein the process controller is constructed to:
generate a chance-based outcome using a random number generator;
receive the multiplayer skill objective achievement for the multiplayer presentation from the interactive controller; and
award the chance-based outcome to a player based on the multiplayer skill objective achievement.

2. The multiplayer variable skill objective electronic gaming machine of claim 1, wherein the interactive controller and the process controller are constructed from the same device.

3. The multiplayer variable skill objective electronic gaming machine of claim 1, wherein the process controller is operatively connected to the interactive controller using a communication link.

4. The multiplayer variable skill objective electronic gaming machine of claim 1, further comprising:
a credit processing controller; and
an enclosure constructed to mount:
a user input device operatively connected to the interactive controller;
a user output device operatively connected to the interactive controller;
a credit input device operatively connected to the credit processing controller; and
a credit output device operatively connected to the credit processing controller

5. The multiplayer variable skill objective electronic gaming machine of claim 4, wherein the process controller is further constructed to:
communicate with the credit input device to receive a credit input;
credit a credit meter with credits based on the incoming credit data;
update the credit meter based on the skill objective achievement of the wager; and
communicate with the credit output device to generate a credit output based on credits transferred off of the credit meter.

6. The multiplayer variable skill objective electronic gaming machine of claim 1, wherein the multiplayer presentation includes a skill disruptor generated in the multiplayer presentation during the player's skillful play of the multiplayer presentation.

7. A multiplayer variable skill objective electronic gaming machine, comprising:
an enclosure constructed to mount:
a user input device;
a user output device;
a credit input device;
a credit output device;
at least one processor operatively connected to the user input device, the user output device, the credit input device, and the credit output device; and
a memory operatively connected to the at least one processor, the memory storing processor executable instructions that when executed by the processor cause the processor to:
communicate with the credit input device to receive a credit input;
credit a credit meter with credits based on the credit data;
generate a chance-based outcome using a random number generator;
generate a multiplayer presentation based on a multiplayer wagering proposition;
detect player interactions of two or more players with the multiplayer presentation;
determine a multiplayer skill objective achievement based on the player interactions;
award the chance-based outcome to a player based on the multiplayer skill objective achievement;
update the credit meter based on the skill objective achievement; and
communicate with the credit output device to generate a credit output based on credits transferred off of the credit meter.

8. The multiplayer variable skill objective electronic gaming machine of claim 7, wherein the multiplayer presentation includes a skill disruptor generated in the multiplayer presentation during the player's skillful play of the multiplayer presentation.
